(19) United States
(12) Patent Application Publication
(10) Pub. No.: US 2025/0039788 A1
(43) Pub. Date: Jan. 30, 2025

(54) METHOD AND APPARATUS FOR REDUCING POWER CONSUMPTION OF USER EQUIPMENT HAVING WAKE-UP RECEIVER IN WIRELESS COMMUNICATION SYSTEM

(71) Applicant: Samsung Electronics Co., Ltd., Suwon-si (KR)

(72) Inventors: Hyewon YANG, Suwon-si (KR); Sungjin PARK, Suwon-si (KR); Jaewon LEE, Suwon-si (KR); Seunghoon CHOI, Suwon-si (KR)

(21) Appl. No.: 18/780,947

(22) Filed: Jul. 23, 2024

(30) Foreign Application Priority Data
Jul. 27, 2023 (KR) 10-2023-0098455

(51) Int. Cl. H04W 52/02

(52) U.S. Cl. CPC H04W 52/0219; H04W 52/0216; H04W 52/0235

(57) ABSTRACT

The disclosure relates to a fifth generation (5G) or sixth generation (6G) communication system for supporting a higher data transmission rate. A method performed by a user equipment (UE) in a wireless communication system is provided. The method includes receiving, from a base station, configuration information associated with a wake-up signal (WUS) for a discontinuous reception (DRX) and monitoring the WUS within an occasion for the WUS based on the configuration information, while a group including the UE is in a DRX mode, wherein the WUS includes information on at least one sub-group associated with the WUS among the group.

### CROSS-REFERENCE TO RELATED APPLICATION(S)

This application is based on and claims priority under 35 U.S.C. § 119 (a) of a Korean patent application number 10-2023-0098455, filed on Jul. 27, 2023, in the Korean Intellectual Property Office, the disclosure of which is incorporated by reference herein in its entirety.

### BACKGROUND

### 1. Field

The disclosure relates to a wireless communication system (or a mobile communication system). More particularly, the disclosure relates to a method and an apparatus for reducing power consumed by a user equipment (UE) having a wake-up receiver.

### 2. Description of Related Art

Fifth generation (5G) mobile communication technologies define broad frequency bands such that high transmission rates and new services are possible, and can be implemented not only in “Sub 6 giga hertz (GHz)” bands, such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods, such as a low density parity check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR UE power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of sixth generation (6G) mobile communication technologies, multi-antenna transmission technologies, such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and artificial intelligence (AI) from the design stage and internalizing end-to-end AI support functions, and next-generation distributed computing technology for implementing services at levels of complexity exceeding the limit of UE operation capability by utilizing ultra-high-performance communication and computing resources.

With the advance of mobile communication systems as described above, various services can be provided, and accordingly there is a need for ways to effectively provide these services, in particular, ways to reduce power consumption of terminals.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and an apparatus for reducing power consumed by a user equipment (UE) having a wake-up receiver in a wireless communication system.

Additional aspects will be set forth in part in the description which follows and, in part, will be apparent from the description, or may be learned by practice of the presented embodiments.

In accordance with an aspect of the disclosure, a method performed by a user equipment (UE) in a wireless communication system is provided. The method includes receiving, from a base station, configuration information associated with a wake-up signal (WUS) for a discontinuous reception (DRX) and monitoring the WUS within an occasion for the WUS based on the configuration information, while a group including the UE is in a DRX mode, wherein the WUS includes information on at least one sub-group associated with the WUS among the group.

In accordance with another aspect of the disclosure, a user equipment (UE) in a wireless communication system is provided. The UE includes a transceiver and a controller coupled with the transceiver and configured to receive, from a base station, configuration information associated with a wake-up signal (WUS) for a discontinuous reception (DRX), and monitor the WUS within an occasion for the WUS based on the configuration information, while a group including the UE is in a DRX mode, wherein the WUS includes information on at least one sub-group associated with the WUS among the group.

According to various embodiments of the disclosure, a service is provided effectively in a wireless communication system. In addition, power consumed by a UE having (or including) a wake-up receiver may be reduced effectively such that, by increasing the service life of the UE's battery, the UE's operating time is increased.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a basic structure of a time-frequency resource domain of a 5G system according to an embodiment of the disclosure;

FIG. 2 illustrates a beam sweeping operation and a time domain mapping structure of a synchronization signal according to an embodiment of the disclosure;

FIG. 3 illustrates a random access procedure according to an embodiment of the disclosure;

FIG. 4 illustrates a procedure according to an embodiment of the disclosure in which user equipment (UE) reports UE capability information to a next generation node B (gNB) according to an embodiment of the disclosure;

FIG. 5 illustrates operations of a gNB for instructing a UE having a WUR to switch the main radio state through a WUS according to an embodiment of the disclosure;

FIG. 6 illustrates a scenario where, if there are two distinguished radios, one radio switches a state of the other radio through a repeatedly transmitted signal according to an embodiment of the disclosure;

FIG. 7 illustrates a method for designing a WUS, based on a message, such that WUS information include information indicating whether a specific UE has to wake up according to an embodiment of the disclosure;

FIG. 8 illustrates a method for designing a WUS, based on a sequence, such that resources for transmitting a sequence that constitutes the WUS, or a WUS sequence, include information indicating whether a specific UE has to wake up according to an embodiment of the disclosure;

FIG. 9 illustrates a method for designing a WUS, based on a message, such that the WUS's transmission index information is included according to an embodiment of the disclosure;

FIG. 10 illustrates a method for designing a WUS, based on a sequence, such that the WUS's transmission index information is included according to an embodiment of the disclosure;

FIG. 11 is a flowchart illustrating operations of a gNB when the influence of erroneous WUS detection by UEs is to be reduced according to an embodiment of the disclosure;

FIG. 12 is a flowchart illustrating operations of a UE when the influence of erroneous WUS detection is to be reduced according to an embodiment of the disclosure;

FIG. 13 is a block diagram illustrating a structure of a UE according to an embodiment of the disclosure; and

FIG. 14 is a block diagram illustrating a structure of a gNB according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The advantages and features of the disclosure and ways to achieve them will be apparent by making reference to embodiments as described below in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a field programmable gate array (FPGA) or an application specific integrated circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in the embodiments may include one or more processors.

In the following description of the disclosure, a detailed description of known functions or configurations incorporated herein will be omitted when it is determined that the description may make the subject matter of the disclosure unnecessarily unclear. Hereinafter, embodiments of the disclosure will be described with reference to the accompanying drawings.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description, the terms “physical channel” and “signal” may be interchangeably used with the term “data” or “control signal”. For example, the term “physical downlink shared channel (PDSCH)” refers to a physical channel over which data is transmitted, but the PDSCH may also be used to refer to the “data”. For example, in the disclosure, the expression “transmit ting a physical channel” may be construed as having the same meaning as the expression “transmitting data or a signal over a physical channel”.

In the following description of the disclosure, upper signaling refers to a signal transfer scheme from a base station to a terminal via a downlink data channel of a physical layer, or from a terminal to a base station via an uplink data channel of a physical layer. The upper signaling may also be understood as radio resource control (RRC) signaling or a media access control (MAC) control element (CE).

In the following description, terms and names defined in the 3rd generation partnership project new radio (3GPP NR, i.e., 5^{th} generation mobile communication standards) will be used for the sake of descriptive convenience. However, the disclosure is not limited by these terms and names, and may be applied in the same way to systems that conform other standards. In addition, the term “terminal” may refer to not only cellular phones, smartphones, Internet of things (IoT) devices, and sensors, but also other wireless communication devices.

In the following description, a base station (BS) is an entity that allocates resources to terminals, and may be at least one of a gNode B, a gNB, an eNode B, an eNB, a Node B, a wireless access unit, a base station controller, and a node on a network. A terminal may include a user equipment (UE), a mobile station (MS), a cellular phone, a smartphone, a computer, or a multimedia system capable of performing a communication function. Of course, examples of the base station and the terminal are not limited to those mentioned above.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a terminal (or UE) transmits data or control signals to a base station (BS) (or eNB or gNB), and the downlink refers to a radio link via which the base station transmits data or control signals to the terminal. The above multiple access scheme separates data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

According to an embodiment of the disclosure, e MBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multiple-input multiple-output (MIMO) transmission technique may be required to be improved. In addition, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services, such as the Internet of things (IoT) in the 5G communication system. mMTC may have requirements, such as support of connection of a large number of UEs in a cell, enhancement coverage of UEs, improved battery time, a reduction in the cost of a UE, and the like, in order to effectively provide the Internet of things. Since the Internet of things provides communication functions while being provided to various sensors and various devices, it must support a large number of UEs (e.g., 1,000,000 UEs/km2) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time, such as 10 to 15 years because it is difficult to frequently replace the battery of the UE.

Lastly, URLLC, which is a cellular-based mission-critical wireless communication service, may be used for remote control for robots or machines, industrial automation, unmanned aerial vehicles, remote health care, emergency alert, and the like. Thus, URLLC must provide communication with ultra-low latency and ultra-high reliability. For example, a service supporting URLLC must satisfy an air interface latency of less than 0.5 ms, and may also require a packet error rate of 10-5 or less. Therefore, for the services supporting URLLC, a 5G system must provide a transmit time interval (TTI) shorter than those of other services, and also may require a design for assigning a large number of resources in a frequency band in order to secure reliability of a communication link.

The above three services considered in the 5G communication system, that is, eMBB, URLLC, and mMTC, may be multiplexed and transmitted in a single system. In this case, different transmission/reception techniques and transmission/reception parameters may be used between services in order to satisfy different requirements of the respective services. Of course, mMTC, URLLC, and eMBB as described above are merely examples of different types of services, and service types to which the disclosure is applicable are not limited to the above examples.

The system transmission bandwidth per single carrier of legacy LTE and LTE-A is limited to a maximum of 20 MHz, but the main objective of 5G systems is to provide super-fast data services at multiple Gbps by utilizing super-broad bandwidths substantially wider than the same. Therefore, 5G systems consider, as candidate frequencies, super-high-frequency bands ranging from multiple GHz to a maximum of 100 GHz, in which super-broad bandwidth frequencies can be secured relatively easily. Additionally, it is possible to secure broad-bandwidth frequencies for 5G systems through frequency relocation or assignment among frequencies bands ranging from hundreds of MHz to multiple GHz which are used in legacy mobile communication systems.

Radio waves in the super-high-frequency bands have wavelengths corresponding to multiple millimeters, and thus are also referred to as millimeter waves (mmWave). However, in super-high-frequency bands, the pathloss of radio waves increases in proportion to the frequency band, thereby decreasing the coverage of mobile communication systems.

In order to overcome the shortcoming of reduced coverage in super-high-frequency bands, a beamforming technology is applied such that, by using multiple antennas, radiation energy of radio waves is concentrated at a target location, thereby increasing the distance reached by radio waves. For example, signals to which the beamforming technology is applied have relatively reduced signal beam widths, and radiation energy is concentrated in the reduced beam widths, thereby increasing the distance reached by radio waves. The beamforming technology may be applied to transmitting and receiving ends, respectively. The beamforming technology is also advantageous in that, besides the increased coverage, interference is reduced in regions not in the beamforming direction. Appropriate operations of the beamforming technology require accurate measurement of transmitted/received beams and a feedback method. The beamforming technology may be applied to control channels or data channels which have one-to-one correspondence between a specific UE and a gNB. In addition, the beamforming technology may also be applied to control channels and data channels for transmitting common signals transmitted by the gNB to multiple UEs in the system, for example, a synchronization signal, a physical broadcast channel (PBCH), and system information, in order to increase the coverage. When the beamforming technology is applied to common signals, a beam sweeping technology needs to be applied such that signals are transmitted in changed beam directions, thereby enabling common signals to reach a UE existing at a specific location in the cell.

As another requirement of 5G systems, there is a need for an ultra-low latency service in which the transmission latency between transmitting and receiving ends is about 1 ms. As a scheme for reducing the transmission latency, there is a need for frame structure design based on a transmission time interval (TTI) shorter than those in LTE and LTE-A. The TTI refers to a basic time unit for performing scheduling, and the TTI of legacy LTE and LTE-A systems is 1 ms which corresponds to the length or one subframe. For example, shorter TTIs for satisfying the requirement of ultra-low latency services in 5G systems than those in legacy LTE and LTE-A systems may include 0.5 ms, 0.25 ms, 0.125 ms, and the like.

In describing the disclosure below, a detailed description of known functions or configurations incorporated herein will be omitted when it is determined that the description may make the subject matter of the disclosure unnecessarily unclear. Hereinafter, embodiments of the disclosure will be described with reference to the accompanying drawings.

In the following description of embodiments of the disclosure, LTE, LTE-A, LTE Pro, or 5G (or NR, next-generation mobile communication) systems will be described by way of example, but the embodiments of the disclosure may be applied to other communication systems having similar backgrounds or channel types. In addition, based on determinations by those skilled in the art, the embodiments of the disclosure may be applied to other communication systems through some modifications without significantly departing from the scope of the disclosure.

According to an embodiment of the disclosure, a signal transmission method by a UE having a wake-up receiver in a mobile communication system may be defined to address the issue of excessive power consumption by the UE and to accomplish a high level of energy efficiency.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

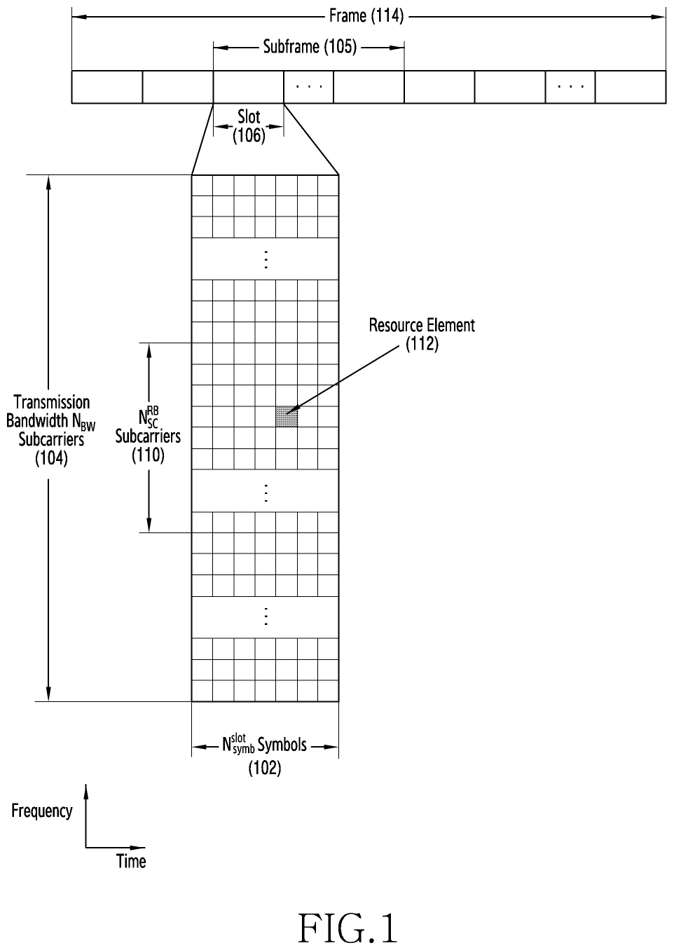

FIG. 1 illustrates a basic structure of a time-frequency resource domain of a 5G system according to an embodiment of the disclosure. For example, FIG. 1 illustrates the basic structure of a time-frequency resource domain which is a radio resource domain used to transmit data or control channels in a 5G system.

Referring to FIG. 1, the horizontal axis denotes the time domain, and the vertical axis denotes the frequency domain. The smallest unit of transmission in the time domain in a 5G system is an orthogonal frequency division multiplexing (OFDM) symbol, a group of N_{symb}^{slot} symbols 102 may constitute one slot 106, and a group of Nₛₗₒₜ^{subframe} slots may constitute one subframe 105. The subframe may have a length of 1.0 ms, and a group of ten subframes may constitute a 10 ms frame 114. The smallest unit of transmission in the frequency domain is a subcarrier, and a total of NBW subcarriers 104 may constitute the entire system transmission bandwidth.

The basic unit of resources in the time-frequency domain is a resource element (RE) 112, which may be represented by an FODM symbol index and a subcarrier index. A resource block (RB) or a physical resource block (PRB) may be defined by N_{sc}^{RB} consecutive subcarriers 110 in the frequency domain. In 5G systems N_{sc}^{RB}=12, and the data rate may increase in proportion to the number of RBs scheduled for the UE.

In a 5G system, the gNB may map data at the RB level, and may generally schedule RBs which constitute one slot with regard to a specific UE. For example, the basic time unit to perform scheduling in 5G systems may be a slot, and the basic frequency unit to perform scheduling may be an RB.

The number N_{symb}^{slot} of OFDM symbols is determined according to the length of a cyclic prefix (CP) which is added to each symbol in order to prevent inter-symbol interference. For example, in case that a normal CP is applied, N_{symb}^{slot}=14 and, in case that an extended CP is applied, N_{symb}^{slot}=12. The extended CP is applied to a system having a longer radio-wave transmission distance than the normal CP, thereby maintaining inter-symbol orthogonality. In the case of the normal CP, the ratio between the CP length and the symbol length may be maintained at a constant value such that the overhead due to the CP remains constant regardless of the subcarrier spacing. For example, the symbol length may increase in case that the subcarrier spacing decreases, thereby increasing the CP length. To the contrary, the symbol length may decrease in case that the subcarrier spacing increases, thereby decreasing the CP length. The symbol length and the CP length may be inversely proportional to the subcarrier spacing.

In order to satisfy various services and requirements in 5G systems, various frame structures may be supported by adjusting the subcarrier spacing. For example, from the viewpoint of the operating frequency band, the larger the subcarrier spacing, the more advantageous to high-frequency-band phase noise restoration. From the viewpoint of the transmission time, the larger the subcarrier spacing, the smaller the symbol length in the time domain. The resulting smaller slot length makes it more advantageous to support a super-low-latency service, such as ultra-reliable and low latency communications (URLLC). From the viewpoint of the cell size, the larger the CP length, the larger cell can be supported, meaning that the smaller the subcarrier spacing, the larger cell can be supported. The term “cell” refers to a region covered by one gNB in connection with mobile communication.

The subcarrier spacing, the CP length, and the like are pieces of information indispensable to OFDM transmission/reception, and efficient transmission/reception is possible only if the gNB and the UE recognize the subcarrier spacing, the CP length, and the like as mutually common values. Table 1 below enumerates the relationship between the subcarrier spacing configuration (μ), the subcarrier spacing (Δf), and the CP length supported in a 5G system.

TABLE 1

| μ | Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

Table 2 enumerates the number (N_{symb}^{slot}) of symbols per one slot, the number (Nₛₗₒₜ^{frame,μ}) of slots per one frame, and the number (Nₛₗₒₜ^{subframe,μ}) of slots per one subframe with regard to each subcarrier spacing configuration (μ) in the case of a normal CP.

TABLE 2

| μ | N_{symb}^{slot} | Nₛₗₒₜ^{frame,μ} | Nₛₗₒₜ^{subframe,μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 3 enumerates the number (N_{symb}^{slot}) of symbols per one slot, the number (Nₛₗₒₜ^{frame,μ}) of slots per one frame, and the number (Nₛₗₒₜ^{subframe,μ}) of slots per one subframe with regard to each subcarrier spacing configuration (u) in the case of an extended CP.

TABLE 3

| μ | N_{symb}^{slot} | Nₛₗₒₜ^{frame,μ} | Nₛₗₒₜ^{subframe,μ} |
|---|---|---|---|
| 2 | 12 | 40 | 4 |

It is expected that 5G systems, in the early state of introduction, will at least coexist with legacy LTE and/or LTE-A (hereinafter, referred to as LTE/LTE-A) systems or operate in a dual mode. Accordingly, legacy LTE/LTE-A may provide UEs with stable system operations, and the 5G systems may play the role of providing UEs with improved services. Therefore, the frame structure of 5G systems need to at least include the frame structure of LTE/LTE-A or a necessary parameter set (subcarrier spacing=15 kHz).

For example, a comparison between a frame structure having a subcarrier spacing configuration μ=0 (hereinafter, referred to as frame structure A) and a frame structure having a subcarrier spacing configuration μ=1 (hereinafter, referred to as frame structure B) shows that, compared with frame structure A, frame structure B has double the subcarrier spacing and the RB size, and has half the slot length and the symbol length. In the case of frame structure B, two slots may constitute one subframe, and 20 subframes may constitute one frame.

To generalize the frame structure of 5G systems, such that the subcarrier spacing, the CP length, the slot length, and the like, which constitute a necessary parameter set, of respective frame structures are related so as to correspond to integer multiples with each other, thereby providing a high degree of extendibility. In addition, a subframe having a fixed length of about 1 ms may be defined to express the legacy time unit regardless of the frame structure.

Frame structures may be applied so as to correspond to various scenarios. From the viewpoint of the cell size, the larger the CP length, the larger cells can be supported, meaning that frame A may support larger cells than frame structure B. From the viewpoint of the operating frequency band, the larger the subcarrier spacing, the more advantageous to high-frequency-band phase noise restoration, meaning that frame structure B may support a higher operating frequency than frame structure A. From the viewpoint of services, the smaller the slot length (basic time unit of scheduling), the more advantageous to supporting a super-low-latency service, such as URLLC, meaning that frame structure B may be more appropriate for an URLLC service than frame structure A.

As used in the following description of the disclosure, the uplink may refer to a radio link via which a UE transmits data or control signals to a base station, and the downlink may refer to a radio link via which the base station transmits data or control signals to the UE.

In an initial access step in which a UE initially accesses a system, the UE may perform downlink time and frequency domain synchronization and acquire a cell identity (ID) from a synchronization signal, transmitted by a base station, through a cell search. In addition, the UE may receive a physical broadcast channel (PBCH) by using the acquired cell ID and acquire a master information block (MIB) as mandatory system information from the PBCH. Additionally, the UE may receive system information (system information block (SIB)) transmitted by the base station to acquire cell-common transmission and reception-related control information. The cell-common transmission and reception-related control information may include random access-related control information, paging-related control information, common control information for various physical channels, or the like.

A synchronization signal is a signal that serves as a reference for a cell search, and for each frequency band, a subcarrier spacing may be applied adaptively to a channel environment, such as phase noise. For a data channel or a control channel, in order to support various services as described above, a subcarrier spacing may be applied differently depending on a service type.

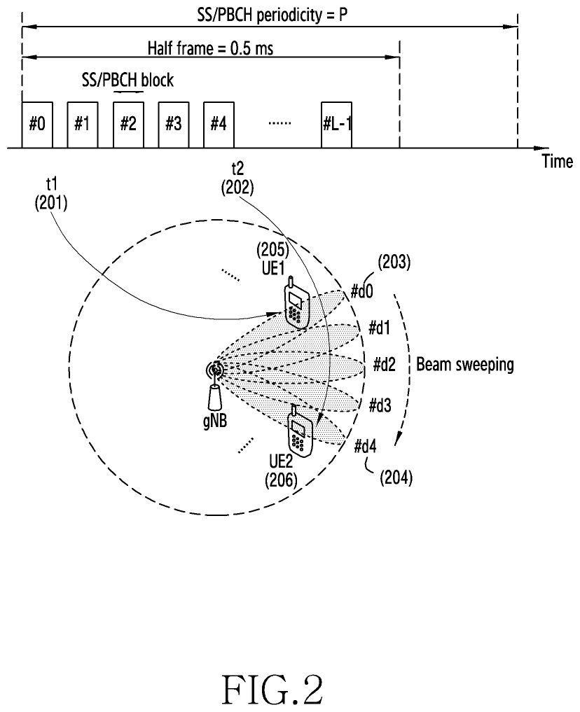

FIG. 2 illustrates a beam sweeping operation and a time domain mapping structure of a synchronization signal according to an embodiment of the disclosure.

For description purposes, the following elements may be defined. Obviously, the example given below is not limiting.
Primary synchronization signal (PSS): A PSS is a signal that serves as a reference for DL time/frequency synchronization, and provides a part of cell ID information.
Secondary synchronization signal (SSS): An SSS serves as a reference for DL time/frequency synchronization, and provides the other part of the cell ID information. Additionally, the SSS may serve as a reference signal for demodulation of a PBCH.
PBCH: provides an MIB which is mandatory system information necessary for the UE to transmit/receive data channels and control channels. The mandatory system information may include search space-related control information indicating radio resource mapping information of a control channel, scheduling control information for a separate data channel for transmission of system information, a system frame number (SFN) which is a frame unit index that serves as a timing reference, and other information.
Synchronization signal/PBCH block (SS/PBCH block) or SSB: An SS/PBCH block is configured by N OFDM symbols and may include a combination of a PSS, an SSS, a PBCH, or the like. For a system to which a beam sweeping technology is applied, an SS/PBCH block is a minimum unit to which beam sweeping is applied. In the 5G system, N=4 may be satisfied. A base station may transmit up to a maximum of L SS/PBCH blocks, and the L SS/PBCH blocks are mapped within a half frame (0.5 ms). In addition, the L SS/PBCH blocks are periodically repeated at predetermined periods P. The base station may inform a UE of period P via signaling. In case that there is no separate signaling of period P, the UE may apply a previously agreed default value.

Referring to FIG. 2, FIG. 2 illustrates an example in which beam sweeping is applied in units of SS/PBCH blocks over time. In the example of FIG. 2, UE 1 205 receives an SS/PBCH block by means of a beam emitted in direction #d0 203 by beamforming applied to SS/PBCH block #0 at time point t1 201. In addition, UE 2 206 receives an SS/PBCH block by means of a beam emitted in direction #d4 204 by beamforming applied to SS/PBCH block #4 at time point t2 202. The UE may acquire, from the base station, an optimal synchronization signal via a beam emitted in the direction where the UE is located. For example, it may be difficult for UE 1 205 to acquire time/frequency synchronization and mandatory system information from the SS/PBCH block through the beam emitted in direction #d4 far away from the location of UE 1.

In addition to the initial access procedure, for the purpose of determining whether the radio link quality of a current cell is maintained at a certain level or higher, the UE may also receive the SS/PBCH block. Furthermore, during a handover procedure in which the UE moves access from the current cell to an adjacent cell, the UE may receive an SS/PBCH block of the adjacent cell in order to determine the radio link quality of the adjacent cell and acquire time/frequency synchronization with the adjacent cell.

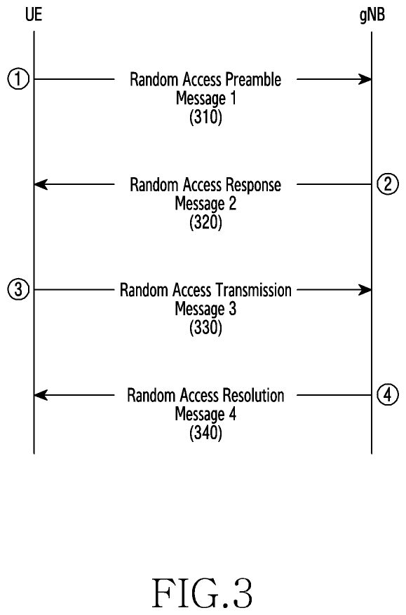

After acquiring an MIB and system information from the base station through the initial access procedure, the UE may perform a random access procedure in order to switch a link to the base station to a connected state (i.e., radio resource control (RRC) connected state or RRC_CONNECTED state). Upon completing the random access procedure, the UE switches to an RRC connected state in which communication between the base station and the UE is possible. Hereinafter, a random access procedure will be described with reference to FIG. 3.

FIG. 3 illustrates a random access procedure according to an embodiment of the disclosure.

Referring to FIG. 3, in the first operation 310 of the random access procedure, the UE may transmit a random access preamble to the gNB. The random access preamble, which is a message initially transmitted by the UE in the random access procedure, may be referred to as message 1. The gNB may measure the transmission latency value between the UE and the gNB from the random access preamble, and may conduct uplink synchronization. The UE may arbitrarily select which random access preamble is to be used, from a random access preamble set given by system information in advance. In addition, the initial transmission power of the random access preamble may be determined according to the pathloss between the gNB and the UE, which is measured by the UE. Furthermore, the UE may determine a transmission beam direction of the random access preamble from a synchronization signal received from the gNB, thereby transmitting the random access preamble.

In the second operation 320, the gNB may transmit an uplink transmission timing adjustment command to the UE, based on the transmission latency value measured from the random access preamble received in the first operation 310. The gNB may also transmit a command to control power and uplink resources to be used by the UE, as scheduling information. The scheduling information may include control information on the UE's uplink transmission beam.

In case that the UE fails to receive a random access response (RAR) (or message 2) which is scheduling information regarding message 3 from the gNB within a predetermined time in the second operation 320, the UE may conduct the first operation 310 again. When conducting the first operation 310 again, the UE may transmit the random access preamble with transmission power increased by a predetermined step (i.e., power ramping), thereby increasing the probability that the gNB will receive the random access preamble.

In the third operation 330, the UE may transmit uplink data (message 3) including the UE's ID to the gNB through a physical uplink shared channel (PUSCH) by using uplink resources assigned in the second operation 320. The transmission timing of the PUSCH for transmitting message 3 may follow a timing control command received from the gNB in the second operation 320. The transmission power of the PUSCH for transmitting message 3 may be determined based on a power control command received from the gNB in the second operation 320 and the power ramping value of the random access preamble. The PUSCH for transmitting message 3 may refer to an uplink data signal initially transmitted to the gNB by the UE after the UE has transmitted a random access preamble.

In the fourth operation 340, upon determining that the UE has performed a random access without colliding with other UEs, the gNB may transmit data (message 4) including the ID of the UE which has transmitted uplink data in the third operation 330 to the corresponding UE. Upon receiving a signal transmitted by the gNB in the fourth operation 340, the UE may determine that the random access is successful. The UE may transmit hybrid automatic repeat request (HARQ)-acknowledgement (ACK) information to the gNB through a physical uplink control channel (PUCCH) so as to indicate successful reception of message 4.

In case that the gNB fails to receive a data signal from the UE due to collision between data transmitted by the UE in the third operation 330 and data from another UE, the gNB may no longer transmit data to the UE. In this case, if the UE fails to receive data transmitted from the gNB in the fourth operation 340 within a predetermined time, the UE may confirm a random access procedure failure and may restart from the first operation 310.

Upon successfully completing the random access procedure, the UE may switch to an RRC connected state, thereby enabling communication between the gNB and the UE. The gNB may receive UE capability information reported by the UE in an RRC connected state and may adjust scheduling with reference to the UE capability information of the UE. The UE may inform the gNB of whether the UE supports a specific function, the maximum allowed value of the function supported by the UE, and the like through the UE capability information. Therefore, UE capability information reported to the gNB by each UE may have a different value with regard to each UE.

For example, as the UE capability information, the UE may report UE capability information including at least a part of the following control information to the gNB. Obviously, the following example is not limitative.
Control information associated with the frequency band supported by the UE
Control information associated with the channel bandwidth supported by the UE
Control information associated with the maximum modulation scheme supported by the UE
Control information associated with the maximum number of beams supported by the UE
Control information associated with the maximum number of layers supported by the UE
Control information associated with channel status information (CSI) reporting supported by the UE
Control information associated with whether the UE supports frequency hoping
Control information associated with the bandwidth when carrier aggregation (CA) is supported
Control information associated with whether cross-carrier scheduling is supported when CA is supported

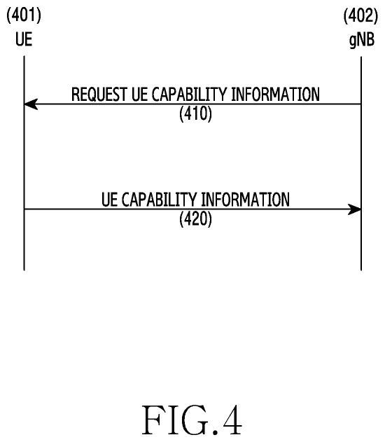

FIG. 4 illustrates a procedure according to an embodiment of the disclosure in which a UE reports UE capability information to a gNB according to an embodiment of the disclosure.

Referring to FIG. 4, in operation 410, a gNB 402 may transmit a UE capability information request message to a UE 401. At the UE capability information request of the gNB, the UE transmits UE capability information to the gNB in operation 420.

Through the above-described process, the UE connected to the gNB may conduct one-to-one communication as a UE in an RRC_CONNECTED state. To the contrary, the UE having no connection may be a UE in an RRC_IDLE state, and operations of the UE in the RRC_IDLE state may be distinguished as follows. Obviously, the following example is not limitative.
A UE-specific discontinuous reception (DRX) cycle operation configured by the upper layer
An operation of receiving a paging message from the core network
Acquiring system information
A neighboring cell-related measurement operation and cell reselection

In 5G systems, a new UE state referred to as RRC_INACTIVE has been defined to reduce the energy and time consumed for the UE's initial access. The RRC_INACTIVE UE may perform the following operations in addition to operations performed by an RRC_IDLE UE. Obviously, the following example is not limitative.
Storing access stratum (AS) information necessary for cell access
A UE-specific DRX cycle operation configured by the RRC layer
Configuring a RAN-based notification area (RNA) which may be utilized during a handover by the RRC layer, and periodically performing update
Monitoring a RAN-based paging message transmitted through an inactive radio network temporary identifier (I-RNTI)

Hereinafter, a scheduling method in which the gNB transmits downlink data to the UE, or instructs the UE to transmit uplink data, will be described.

Downlink control information (DCI) refers to control information transmitted to from the gNB to a UE through the downlink, and may include downlink data scheduling information or uplink data scheduling information regarding a specific UE. In general, the gNB may independently channel-code DCI with regard to each UE and may transmit the same to each UE through a physical downlink control channel (PDCCH).

With regard to a UE to be scheduled, the gNB may apply and operate a predetermined DCI format according to the purpose, such as whether the same is scheduling information regarding downlink data (downlink assignment), whether the same is scheduling information regarding uplink data (uplink grant), or whether the same is DCI for power control.

The gNB may transmit downlink data to the UE through a physical downlink shared channel (PDSCH). Scheduling information, such as detailed mapping locations in time and frequency domains of the PDSCH, the modulation scheme, HARQ-related control information, and power control information, may be provided from the gNB to the UE through DCI related to downlink data scheduling information among DCI transmitted through a PDCCH.

The UE may transmit uplink data to the gNB through a physical uplink shared channel (PUSCH). Scheduling information, such as detailed mapping locations in time and frequency domains of the PUSCH, the modulation scheme, HARQ-related control information, and power control information, may be provided from the gNB to the UE through DCI related to uplink data scheduling information among DCI transmitted through a PDCCH.

The time-frequency resource to which the PDCCH is mapped is referred to as a control resource set (CORESET). The CORESET may be configured in all or part of frequency resources in a bandwidth supported by the UE in the frequency domain. One or multiple OFDM symbols may be configured as the same in the time domain, and this may be defined as a control resource set (CORESET) duration. The gNB may configure multiple CORESETs for the UE through upper layer signaling (for example, system information, MIB, RRC signaling). The description that a CORESET is configured for the UE may mean that information, such as the CORESET identity, the CORESET's frequency location, and the CORESET's symbol length is provided thereto. Pieces of information provided from the gNB to the UE to configure a CORESET may include at least a part of the information included in Table 4 below:

```
TABLE 4
ControlResourceSet ::=  SEQUENCE {
  controlResourceSetId  ControlResourceSetId,
      (CORESET identity)
  frequencyDomainResources  BIT STRING (SIZE (45)),
      (frequency domain resources)
      duration  INTEGER (1..maxCoReSetDuration),
      (CORESET duration)
  cce-REG-MappingType  CHOICE {
      (CCE-to-REG mapping type)
    interleaved  SEQUENCE {
      reg-BundleSize  ENUMERATED {n2, n3, n6},
        (REG bundle size)
        interleaverSize  ENUMERATED {n2, n3, n6},
        (interleaver size)
        shiftIndex
INTEGER(0..maxNrofPhysicalResourceBlocks-1)  OPTIONAL -- Need S
        (interleaver shift)
    },
    nonInterleaved  NULL
  },
  precoderGranularity  ENUMERATED {sameAsREG-bundle,
allContiguousRBs},
      (precoding unit)
      tci-StatesPDCCH-ToAddList  SEQUENCE(SIZE (1..maxNrofTCI-
StatesPDCCH)) OF TCI-StateId OPTIONAL, -- Cond NotSIB1-initialBWP
      (QCL configuration information)
  tci-StatesPDCCH-ToReleaseList SEQUENCE(SIZE (1..maxNrofTCI-
StatesPDCCH)) OF TCI-Stateld OPTIONAL, -- Cond NotSIB1-initialBWP
      (QCL configuration information)
  tci-PresentInDCI  ENUMERATED {enabled}
OPTIONAL, -- Need S
      (QCL indicator configuration information in DCI)
  pdcch-DMRS-ScramblingID  INTEGER (0..65535)
OPTIONAL, -- Need S
      (PDCCH DMRS scrambling identifier)
}
```

A CORESET may be configured by N_{RB}^{CORESET} RBs in the frequency domain and N_{symb}^{CORESET}=∈{1,2,3} symbols in the time domain. An NR PDCCH may be configured by one or multiple control channel elements (CCEs). One CCE may be configured by six resource element groups (REGs), and each REG may be defined as one RB during one OFDM symbol. In one CORESETs, REGs may be indexed in the time-first order, starting from REG index 0 in the CORESET's first CORESET symbol/lowest RB.

As a PDCCH-related transmission method, an interleaved type and a non-interleaved type may be supported. The gNB may configure, for the UE, whether interleaved or non-interleaved transmission is performed with regard to each CORESET through upper layer signaling. Interleaving may be performed at the REG bundle level. The REG bundle may be defined as one REG or a set of multiple REGs. Based on the gNB's configuration regarding whether interleaved or non-interleaved transmission is performed, the UE may determine a CCE-to-REG mapping type in the corresponding CORESET as in Table 5 below:

```
TABLE 5
The CCE-to-REG mapping for a control-resource set can be interleaved or
non-interleaved and is described by REG bundles:
-  REG bundle i is defined as REGs ^{{iL,iL+1,..., iL+L-1}} where L is the REG
bundle size, i = 0,1, . . . , N_{REG}^{CORESET} / L − 1, and N_{REG}^{CORESET} = N_{RB}^{CORESET} N_{symb}^{CORESET}
is the number of REGs in the CORESET
-  CCE j consists of REG bundles ^{{f(6j/L), f(6j/L+1),..., f(6j/L+6/L-1)}}
where ^{f (•)} is an interleaver
For non-interleaved CCE-to-REG mapping, L = 6 and f (x) = x.
For interleaved CCE-to-REG mapping, L ∈ {2,6}for N_{symb}^{CORESET} = 1 and L ∈
{N_{symb}^{CORESET} , 6} for N_{symb}^{CORESET} ∈ {2,3}. The interleaver is defined by
    f (x) = (rC + c +n_{shift}) mod (N_{REG}^{CORESET} / L)
          x = cR + r
        r = 0,1, . . . , R − 1
        c = 0,1, . . . , C − 1
      C = N_{REG}^{CORESET} / (LR)
where ^{R ∈{2,3,6}} .
```

The gNB may provide the UE with configuration information regarding to which symbol the PDCCH is mapped in the slot, the transmission period, and the like through signaling.

A description of a search space for a PDCCH is as follows. The number of CCEs necessary to transmit a PDCCH may be 1, 2, 4, 8, or 16 according to aggregation levels (ALs), and different number of CCEs may be used to implement link adaption of a downlink control channel. For example, in the case of AL=L, one downlink control channel may be transmitted through L CCEs. The UE performs blind decoding for detecting a signal while being no information regarding the downlink control channel, and to this end, a search space indicating a set of CCEs may be defined. The search space is a set of downlink control channel candidates including CCEs which the UE needs to attempt to decode at a given AL, and since 1, 2, 4, 8, or 16 CCEs may constitute a bundle at various ALs, the UE may have multiple search spaces. A search space set may be defined as a set of search spaces at all configured ALs.

The search spaces may be classified into common search spaces (CSSs) and UE-specific search spaces (USSs). A group of UEs or all UEs may search a common search space of the PDCCH in order to receive cell-common control information, such as dynamic scheduling regarding system information (SIB) or a paging message. For example, the UE may receive PDSCH scheduling allocation information for reception of system information by searching the common search space for the PDCCH. In the case of a common search space, a group of UEs or all UEs need to receive the PDCCH, and the common search space may thus be defined as a predetermined set of CCEs. Scheduling allocation information regarding a UE-specific PDSCH or PUSCH may be received by searching the UE-specific search space for the PDCCH. The UE-specific search space may be defined UE-specifically as a function of various system parameters and the identity (ID) of the UE.

Configuration information of the search space for the PDCCH may be configured for the UE by the base station through upper layer signaling (e.g., SIB, MIB, or RRC signaling). For example, the base station may provide the UE with configurations, such as the number of PDCCH candidates at each aggregation level L, the monitoring cycle regarding the search space, the monitoring occasion with regard to each symbol in a slot regarding the search space, the search space type (common search space or UE-specific search space), a combination of an RNTI and a DCI format to be monitored in the corresponding search space, a control resource set index for monitoring the search space, and the like. For example, parameters of the search space for the PDCCH may include the following pieces of information given in Table 6 below.

```
TABLE 6
SearchSpace ::=  SEQUENCE {
  searchSpaceId  SearchSpaceId,
    (search space identity)
```

| | |
|---|---|
| controlResourceSetId ControlResourceSetId | OPTIONAL, -- |

```
Cond SetupOnly
    (CORESET identity)
  monitoringSlotPeriodicityAndOffset CHOICE {
    (monitoring slot level periodicity and offset)
      sl1  NULL,
      sl2  INTEGER (0..1),
      sl4  INTEGER (0..3),
      sl5  INTEGER (0..4),
      sl8  INTEGER (0..7),
      sl10  INTEGER (0..9),
      sl16  INTEGER (0..15),
      sl20  INTEGER (0..19),
      sl40  INTEGER (0..39),
      sl80  INTEGER (0..79),
      sl160  INTEGER (0..159),
      sl320  INTEGER (0..319),
      sl640  INTEGER (0..639),
      sl1280  INTEGER (0..1279),
      sl2560  INTEGER (0..2559)
  }  OPTIONAL, -- Cond Setup
```

| | |
|---|---|
| duration INTEGER (2..2559) | OPTIONAL, -- |

```
Need R
    (monitoring duration)
  monitoringSymbols WithinSlot  BIT STRING (SIZE (14))
OPTIONAL, -- Cond Setup
    (monitoring slot location within slot)
  nrofCandidates  SEQUENCE {
    (number of PDCCH cabidates according to aggregation levels)
      aggregationLevel1  ENUMERATED {n0, n1, n2, n3, n4, n5, n6, n8},
      aggregationLevel2  ENUMERATED {n0, n1, n2, n3, n4, n5, n6, n8},
      aggregationLevel4  ENUMERATED {n0, n1, n2, n3, n4, n5, n6, n8},
      aggregationLevel8  ENUMERATED {n0, n1, n2, n3, n4, n5, n6, n8},
      aggregationLevel16  ENUMERATED {n0, n1, n2, n3, n4, n5, n6, n8}
```

| | |
|---|---|
| } | OPTIONAL, -- Cond Setup |

```
  searchSpaceType  CHOICE {
    (search space type)
      common  SEQUENCE {
        (common search space)
        dci-Format0-0-AndFormat1-0  SEQUENCE {
          . . .
        }  OPTIONAL, -- Need R
        dci-Format2-0  SEQUENCE {
          nrofCandidates-SFI  SEQUENCE {
            aggregationLevel1  ENUMERATED {n1, n2}
OPTIONAL, -- Need R
            aggregationLevel2  ENUMERATED {n1, n2}
OPTIONAL, -- Need R
            aggregationLevel4  ENUMERATED {n1, n2}
OPTIONAL, -- Need R
            aggregationLevel8  ENUMERATED {n1, n2}
OPTIONAL, -- Need R
            aggregationLevel16  ENUMERATED {n1, n2}
OPTIONAL -- Need R
          },
          . . .
```

| | |
|---|---|
| } | OPTIONAL, -- Need R |

```
        dci-Format2-1  SEQUENCE {
          . . .
        }  OPTIONAL, -- Need R
        dci-Format2-2  SEQUENCE {
          . . .
        }  OPTIONAL, -- Need R
        dci-Format2-3  SEQUENCE {
          dummy1  ENUMERATED {sl1, sl2, sl4, sl5, sl8, sl10,
sl16, sl20} OPTIONAL, -- Cond Setup
          dummy2  ENUMERATED {n1, n2},
          . . .
        }  OPTIONAL -- Need R
      },
      ue-Specific  SEQUENCE {
        (UE-specific search space)
        dci-Formats  ENUMERATED {formats0-0-And-1-0,
formats0-1-And-1-1},
        . . . ,
      }
  }  OPTIONAL -- Cond Setup2
}
```

According to configuration information, the base station may configure one or multiple search space sets for the UE. According to an embodiment of the disclosure, the base station may configure search space set 1 and search space set 2 for the UE. In search space set 1, the UE may be configured to monitor DCI format A scrambled by an X-RNTI in a common search space, and in search space set 3, the UE may be configured to monitor DCI format B scrambled by a Y-RNTI in a UE-specific search space.

According to configuration information, one or multiple search space sets may exist in a common search space or a UE-specific search space. For example, search space set #1 and search space set #2 may be configured as a common search space, and search space set #3 and search space set #4 may be configured as a UE-specific search space.

In a UE-specific space, the UE may monitor combinations of DCI formats and RNTIs given below. Obviously, the example given below is not limiting.
DCI format 0_0/1_0 with cyclic redundancy check (CRC) scrambled by cell RNTI (C-RNTI), configured scheduling RNTI (CS-RNTI), semi-persistent channel state information RNTI (SP-CSI-RNTI), random access RNTI (RA-RNTI), temporary C-RNTI (TC-RNTI), paging RNTI (P-RNTI), system information RNTI (SI-RNTI)
DCI format 2_0 with CRC scrambled by slot formation indicator RNTI (SFI-RNTI)
DCI format 2_1 with CRC scrambled by interruption RNTI (INT-RNTI)
DCI format 2_2 with CRC scrambled by transmission power control for PUSCH RNTI (TPC-PUSCH-RNTI), transmission power control for PUCCH RNTI (TPC-PUCCH-RNTI)
DCI format 2_3 with CRC scrambled by transmission power control for sounding reference signal RNTI (TPC-SRS-RNTI)

In a UE-specific search space, the UE may monitor combinations of DCI formats and RNTIs given below. Obviously, the example given below is not limiting.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

The RNTIs enumerated above may follow the definition and usage given below.

C-RNTI: used to schedule a UE-specific PDSCH or PUSCH

TC-RNTI: used to schedule a UE-specific PDSCH
CS-RNTI: used to schedule a semi-statically configured UE-specific PDSCH
RA-RNTI: used to schedule a PDSCH in a random access step
P-RNTI: used to schedule a PDSCH in which paging is transmitted
SI-RNTI: used to schedule a PDSCH in which system information is transmitted
INT-RNTI: used to indicate whether a PDSCH is punctured
   TPC-PUSCH-RNTI: used to indicate a power control command regarding a PUSCH
   TPC-PUCCH-RNTI: used to indicate a power control command regarding a PUCCH
TPC-SRS-RNTI: used to indicate a power control command regarding an SRS

The DCI formats enumerated above may follow the definitions given in Table 7 below.

TABLE 7

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and |
| | OFDM symbol(s) where UE may assume no |
| | transmission is intended for the UE |
| 2_2 | Transmission of TPC commands for PUCCH |
| | and PUSCH |
| 2_3 | Transmission of a group of TPC commands |
| | for SRS transmissions by one or more UEs |

In a 5G system, the search space at aggregation level L in connection with CORESET p and search space set s may be expressed by Equation 1 below.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{p , s , max}^{( L )}} ⌋ + {n}_{CI} ) mod ⌊ {N}_{C C E , p} / L ⌋ \} + i \qquad Equation 1$$

L: aggregation level
n_{CI}: carrier index
N_{CCE,p}: total number of CCEs existing in control resource set p
n_{s,f}^{μ}: slot index
M_{s,max}^{(L)}: number of PDCCH candidates at aggregation level L
m_{s,n}_{_{CI}}=0, . . . , M_{s,max}^{(L)}−1: PDCCH candidate index at aggregation level L
i=0, . . . , L−1

Y_{p,n}_{_{s,f}}_{^{μ}}=(Aₚ·Y_{p,n}_{_{s,f}}_{^{μ}}₌₁)mod D, Y_{p,-1}=n_{RNTI}≠0, Aₚ=39827 for p mod 3=0, Aₚ=39829 for p mod 3=1, Aₚ=39839 for p mod 3=2, D=65537
n_{RNTI}: UE identity

The Y_{p,n}_{_{s,f}}_{^{μ}} value may correspond to 0 in the case of a common search p,n's,f space.

The Y_{p,n}_{_{s,f}}_{^{μ}} value may correspond to a value changed by the UE's identity (C-RNTI or ID configured for the UE by the base station) and the time index in the case of a UE-specific search space.

As described above, signal transmission/reception in super-broad bandwidths ranging from tens or hundreds of MHz or multiple GHz may be supported to accomplish a super-fast data service at multiple Gbps in 5G systems. Signal transmission/reception in super-broad bandwidths may be supported through a single component carrier (CC) or through a carrier aggregation (CA) technology which combines multiple CCs. If the mobile communication operator fails to secure frequencies in a bandwidth enough to provide a super-fast data service by using a single CC, the CA technology combines respective CCs having a relatively small bandwidth size such that the total sum of frequency bandwidths is increased, consequently enabling a super-fast data service.

5G systems are designed and developed based on all of various use cases. Besides the standby time, reliability, and availability, the UE's energy efficiency is critical in 5G systems. 5G UEs need to be changed on a weekly or daily basis according to the individuals' time of use. In general, 5G UEs consume tends of mW in an RRC_IDLE or RRC_INACTIVE state, and consume hundreds of mW in an RRC_CONNECTED state. Design for extending the battery life is an indispensable element not only for better user experiences, but also for improved energy efficiency. Energy efficiency is more important to UEs having no continuous energy supply, for example, UEs using small rechargeable and single coin cell batteries. Among 5G use cases, sensors and actuators are arranged for monitoring, measurement, charging, and the like on a wide scale. In general, batteries for sensors or actuators cannot be rechanged, and are expected to last at least a number of years. In addition, wearable devices, such as smartwatches, rings, eHealth-related devices, and medical monitoring devices can hardly last a maximum of 1-2 weeks, depending on the time of use.

As a method for reducing power consumed by 5G UEs, UEs may operate in a DRX mode. A UE to which DRX is applied may be activated only at a specific time in a periodic manner, thereby transmitting/receiving information. Reduction in power consumed by the UE depends on the length of the range in which the UE is activated, for example, the paging cycle. It is thus expected that an extended discontinuous reception (eDRX) cycle having a large value will be used to satisfy battery life requirements.

However, use of the eDRX cycle may be inappropriate for a service having a short standby time because a long battery life is maintained based on a long standby time. For example, in the case of use for fire sensing and extinguishing, it is within 1-2 seconds from the timepoint at which a fire is detected by a sensor that fire shutters need to be closed, and sprinklers need to be activated by actuators. For example, in a use case having a critical standby time, an eDRX cycle having a large value cannot conventionally satisfy latency requirements, and the eDRX may thus be inappropriate for such a case.

A 5G UE needs to periodically wake up once per DRX cycle in order to identify whether there is data to be received, and this may cause unnecessary power consumption during a period of time without signaling or data traffic. In case that the UE can wake up only when the UE needs to be activated, for example, when there is data (for example, paging information) that the UE needs to receive, in order to address such an issue, power consumption may be reduced remarkably. To this end, a UE according to a proposed embodiment may trigger the operation of a main radio or a main transceiver (which may be understood as a legacy NR radio device or a signal transmission/reception device capable of performing data communication by using cellular communication or the like) by using a wake-up signal (WUS), and may operate the main radio only when data transmission/reception is necessary by using a wake-up receiver (WUR) which is a separate receiver capable of monitoring the WUS with super-low power.

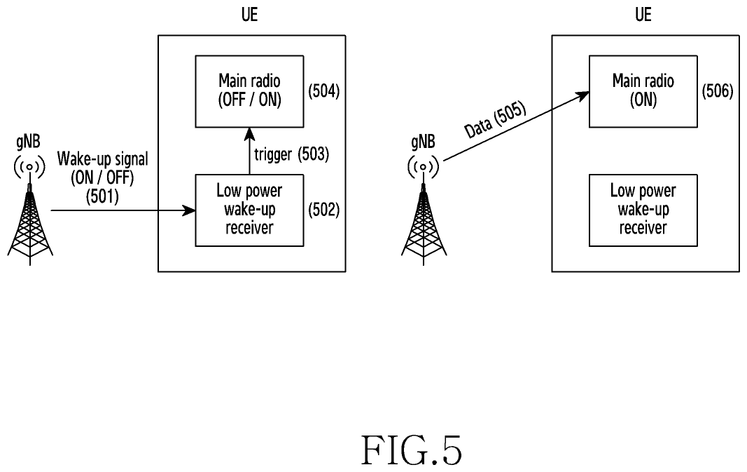

FIG. 5 illustrates operations of a gNB for instructing a UE having a WUR to switch the main radio state through a WUS according to an embodiment of the disclosure.

Referring to FIG. 5, the gNB transmits a WUS 501 indicating ON or OFF to the UE. The description that the WUS 501 indicates ON or OFF may mean that the UE determines, based on the WUS 501, whether or not to monitor the PDCCH during the following on-duration. For example, upon receiving a WUS 501 from the gNB, the UE may monitor the PDCCH during the on-duration that follows the WUS 501, and upon receiving no WUS 501 from the gNB, the UE may skip or omit PDCCH monitoring during the on-duration following the timepoint at which a WUS 501 is supposed to be received.

In case that the gNB transmits a WUS 501 indicating ON, the UE may receive the WUS 501 by using a WUR 502. According to whether the received signal is On or OFF information (or according to whether a WUS 501 is received or not), the UE may trigger (503) and wake up the main radio (or main transceiver) 504 which is in an OFF state, or may power off the main radio (or main transceiver) which is in an ON state. Instead of fully turning the main radio 504 off, the UE may, in some cases, configure a deep sleep state in which most parts or components of the main radio are turned off, and indispensable parts (for example, internal clocks and memories) keep operating.

In case that a WUS corresponding to ON is transmitted from the gNB to the UE (or in case that the WUS is normally received by the UE) due to the occurrence of traffic 505 to be sent from the gNB to the UE, the UE's main radio is turned on 506, and the UE may receive the downlink signal transmitted by the gNB through the main radio instead of the WUR. Power consumed to monitor the WUS depends on WUS design and the hardware module of the WUR used to detect and process signals, and maximized gain may thus be expected in the case of IoT use (such as industrial sensors and controllers), in particular, and in connection with devices which include wearables, which are sensitive to power, and which have small form factors.

When multiple UEs are supported in a 5G system, it is necessary to be able to transmit a WUS for a specific UE among the multiple UEs, or a specific UE group, in order to reduce the UEs' power through a WUS. For example, in case that a WUS for a specific UE is transmitted, the UE may wake up only when a UE specific WUS is received, thereby reducing unnecessary power consumption. In case that a WUS for a specific UE group is transmitted, UEs may wake up upon receiving a UE group WUS, and may identify whether there is signaling or data to be received. If even one UE in a group needs to wake up, the gNB transmits a UE group WUS, and other UEs in the group, which need not wake up, may unnecessarily consume power. Therefore, the smaller the number of UEs belonging to the same group, the less power unnecessarily consumed by UEs. This requires WUS design capable of reducing the number of UEs in the same group, or transmitting a UE-specific WUS. For efficient use of resources, multiple UE-specific WUSs or UE group WUSs may be transmitted in the same time and frequency resources. UEs which receive WUSs in the same time and frequency resources need to know in advance how WUSs to be received thereby can be specified by utilizing information (for example, UE ID) given in advance such that the UEs can correctly determine whether WUSs are received or not. For example, when multiple UEs receive WUSs in the same resource, designing the WUSs such that the largest number of UE-specific WUSs or UE group WUSs can be distinguished is advantageous to decreasing the amount of resources for WUS transmission while reducing the average power consumption by the UEs.

However, the larger the number of candidate UE-specific WUSs or UE group WUSs which can be transmitted in the same resource, the larger the probability that respective UEs will fail to correctly detect the WUSs. There may be two types of cases in which errors occur in the WUS detection process as described above. In the first case, the gNB has transmitted a WUS for a specific UE (group), but the UE has failed to detect the WUS, and such an erroneous detection case may be referred to as WUS miss detection. In the second case, the gNB has transmitted a WUS for a specific UE (group), but another UE which needs not wake up incorrectly recognizes in the WUS detection process that the WUS has been transmitted thereto, and then wakes up. Such an erroneous detection case may be referred to as a WUS false alarm. In general, prior to designing a new signal, an appropriate target miss detection rate (MDR) and a target false alarm rate (FAR), which the signal needs to satisfy, is configured. Therefore, appropriate MDR and FAR requirements need to be configured, when designing a WUS received by a WUR, in order to reduce the influence of detection errors.

One of universal methods for detecting a WUS transmitted from the gNB is to calculate the cross correlation coefficient of the received signal and the WUS to be detected by the UE, to compare the same with a specific threshold, and then to determine whether the WUS is received. If the threshold for WUS detection is raised, the FAR decreases, but the MDR increases. To the contrary, if the threshold for WUS reception is lowered, the MDR decreases, but the FAR increases. As such, the MDR and FAR of the WUS have a tradeoff relationship, and a complicated receiver structure is thus necessary to design a signal having low values for both rates. However, in order to minimize power consumed by the UE, it is also necessary to reduce power consumed by the WUR to the maximum extent through a simple receiver structure and a simple WUS detection process. Therefore, there is a need to consider methods for minimizing the influence of miss detection and false alarm when receiving a WUS, while having a relatively simple receive structure (for example, low power WUR (LP-WUR)) in connection with WUS design.

Based on the influence on the increased power consumption by the UE, configuring the FAR to be lower than the MDR helps reducing the power consumption by the UE. This is because, if the FAR of a WUS is high, there is an increased probability that the UE will wake up due to a WUS for another UE (group), and power consumption also increases. On the other hand, if the MDR of a WUS is high, information necessary for the UE may fail to be received, or the time taken to receive the information may increase. In addition, if a specific UE fails to receive a transmitted UE group WUS, retransmission of the WUS may increase power consumed by other UEs in the group. For example, if a UE group WUS has been transmitted to indicate RRC connection of a specific UE in a group, and if the UE has failed to receive the WUS, the gNB may transmit the UE group WUS multiple times to wake up the UE. In such a case, other UEs belonging to the same group as the corresponding UE may unnecessarily wake up repeatedly, thereby increasing power consumption. Therefore, it is necessary to consider a method for minimizing the influences of WUS miss detection when the MDR of the WUS is configured higher than the FAR thereof from the viewpoint of reducing the power consumed by the UE.

Hereinafter, methods for designing and transmitting a WUS for minimizing the influence of WUS detection errors and procedures of the gNB and the UE will be described with reference to detailed embodiments.

### First Embodiment

In the first embodiment of the disclosure, methods for designing and transmitting a WUS such that a low MDR can be accomplished even with a receiver which has a relatively low degree of complexity, and which consumes less power, will be described. More specifically, a method for transmitting a WUS capable of reducing the WUS's MDR will be described.

In case that the gNB has transmitted a specific signal and has expected a response from a UE, but has received no response from the UE, the gNB may determine that the UE has received no signal from the gNB and may retransmit the specific signal. Likewise, if the gNB has transmitted a WUS regarding a specific UE and has expected that the UE's main radio will wake up and perform a random access procedure, but if the UE has not performed the procedure, the gNB may determine that the UE has filed to receive the WUS and may retransmit the WUS. However, WUS retransmission not only delays the data reception time, but may substantially increase the average power consumption by multiple UEs if the WUS is transmitted at the UE group level. This is because, if the gNB retransmits a WUS due to failed reception of the WUS by the UE in the group, which is supposed to receive the WUS and to perform a random access procedure, other UEs in the group unnecessarily wake up multiple times, thereby increasing power consumption.

Therefore, it may be considered that the gNB will send a WUS multiple times in advance. For example, if the gNB repeatedly transmits a WUS for waking up a specific UE or a specific UE group prior to the timepoint at which the UE's main radio needs to wake up, UEs supposed to wake up according to the WUS may detect the repeatedly received WUS and may perform an operation of determining whether or not to wake up the main radio. This may reduce the UE's WUS MDR.

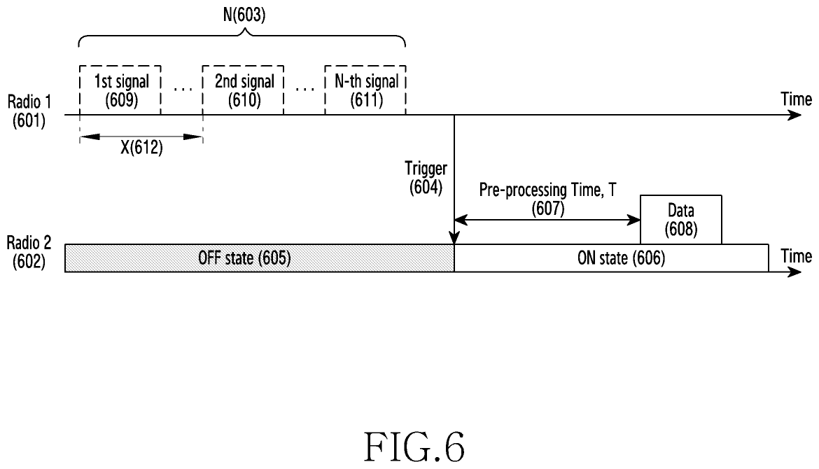

FIG. 6 illustrates a scenario where, if there are two distinguished radios, one radio switches a state of the other radio through a repeatedly transmitted signal according to an embodiment of the disclosure.

Referring to FIG. 6, a timeline regarding two radios 601 and 602 is illustrated. Considering that radio 1 601 is the UE's LP-WUR, and radio 2 602 is the UE's main radio, FIG. 6 may be understood as expressing detailed operations of the LP-WUR and the main radio illustrated in FIG. 5. Although reference numerals 601 and 602 in FIG. 6 are not limited to the UE's LP-WUR and the UE's main radio, it will be assumed in the following description that reference numerals 601 and 602 denote the LP-WUR and main radio of UE A, respectively, for convenience of description. Therefore, signals 609-611 received by radio 1 601 (that is, LP-WUR) may be WUSs.

Referring to FIG. 6, in case that the LP-WUR 601 of UE A receives WUSs 609, 610, and 611 repeatedly transmitted by the gNB N 603 times and then determines that a WUS for UE A or the group to which UE A belongs has been received, the LP-WUR 601 may trigger 604 so as to wake up the main radio 602. As illustrated in FIG. 6, if the main radio 602 of UE A switches the state from the OFF state 605 to the ON state 606, the trigger 604 may then be an operation in which the LP-WUR 601 wakes up the main radio 602. The OFF state 605 may be defined differently, depending on implementation, and may be, for example, a state in which all hardware components of the main radio are turned off, or a deep sleep state in which only minimum hardware remains turned on and consumes power. On the other hand, the ON state 606 may be a state in which most hardware components of the main radio are turned on and activated such that signals can be transmitted/received. Specifically, a pre-processing time corresponding to T 607 may be necessary to reach a state in which necessary information 608 (for example, downlink signal or data) may be transmitted/received after the state of the main radio is switched from the OFF state 605 to the ON state 606. Operations performed by the main radio during T 607 may vary depending on which part has been turned off in the OFF state 605, how long the OFF state 605 has lasted, and the like. For example, in case that most hardware components have been turned off, and if the OFF state 605 has lasted for a relatively long time, the main radio may spend a long time to conduct a process of booting hardware after switching to the ON state 606, a process of synchronizing the frequency and time through SSB reception, a process of adjusting the automatic gain control (AGC) circuit, and the like.

In order to receive repeatedly transmitted signals 609, 610, and 611, the UE needs to have in advance information regarding whether the signals are transmitted repeatedly, how many times they are transmitted repeatedly, and the like. In order to reduce the MDR of a specific signal to be received by radio 1 601, information regarding how many times the signal is transmitted repeatedly, and the timepoint of repeated transmission may be defined in advance, assuming that repeated transmission is supported, or may be implicitly provided to respective UEs or UE groups through a predetermined formula. However, in case that repeated transmission is forced, there is an increased burden on resource utilization by the gNB, and the gNB may thus configure whether the signal received by radio 1 601 will be transmitted repeatedly or not, for the UE. Specifically, the gNB may configure whether or not to use the repeated transmission function with regard to all signals that radio 1 601 may receive, before the operation of radio 1 601 is activated.

In addition, if multiple types of signals are received by radio 1 601, repeated transmission-related information may be configured differently according to the signal type. Particularly, repeated transmission-related information may be configured differently according to the importance or characteristics of information 608 to be transmitted/received after radio 2 602 is activated by radio 1 601. As a detailed example, information 608 transmitted/received by radio 2 602 of the UE in an RRC_IDLE/INACTIVE state is usually paging information. Therefore, the gNB may transmit paging information to inform UEs of a change in system information, may transmit emergency information to UEs, such as a public warming system (PWS), and may instruct a UE to switch to an RRC_CONNECTED state because there is information to receive. In such a case, in the case of information having a relatively high degree of importance to be received by a UE, the gNB may configure repeated transmission to be performed, or configure repeated transmission to be performed more times. Particularly, in case that a UE cannot receive paging information instructing the same to switch to an RRC_CONNECTED state, the paging information will be retransmitted in an increased range, and other UEs in the same group unnecessarily receive the paging information multiple times accordingly, and may thus consume more power. Therefore, as in Table 8 below, the number of times the gNB repeatedly transmits a signal to radio 1 may vary depending on the type of information 608 to be received by radio 2 602 after radio 1 601 of the UE triggers 604 radio 2 602.

TABLE 8

| | Number of |
|---|---|
| Data information (608) | repetitions N (603) |
| System information update | 1 |
| notification | |
| PWS notification | 2 |
| RRC connection command | 3 |

Table 8 above corresponds to a case in which repeatedly transmitted signals 609, 610, and 611 are received by radio 1 of UEs in the RRC_IDLE/INACTIVE state. The value of the number of repetitions (N) in Table 8 is only an example, and the type of data information defined in Table 8 is only an example too, and may vary as desired. Particularly, a signal for UEs in the RRC_CONNECTED state has a different type of information transmitted/received by radio 2 602, and a different number of repetitions (N) may be mapped to other pieces of information.

Meanwhile, repeated transmission may be performed through time resources as in FIG. 6, and repeated transmission may also be performed through frequency resources to reduce the data transmission/reception time delay. Whether repeated transmission in frequency resources is possible or not may be determined according to whether radio 1 601 is capable of simultaneously receiving signals repeatedly transmitted in multiple frequency resources. In the case of a UE in the RRC_CONNECTED state, the gNB is provided with the capability of radio 1 601 of the UE in advance, and thus may know in advance, when radio 1 601 of the UE in the RRC_CONNECTED state receives signals, whether the same can receive a signal repeatedly transmitted in a frequency resource. Therefore, the gNB may include and configure information regarding repeated transmission in frequency resources according to the previously provided capability of the UE.

Meanwhile, in the case of UEs in the RRC_IDLE/INACTIVE state, the gNB may not be aware of the capability of radio 1 601 of the UEs. Therefore, although the gNB repeatedly transmits signals in the frequency domain, UEs may receive signals only at some frequencies among the same. Alternatively, in case that a UE receives a configuration indicating that the gNB will repeatedly transmit a signal for radio 1 601 in a frequency resource, signal reception by radio 1 601 may be deactivated. Alternatively, when the gNB transmits a signal (for example, WUS) for radio 1 601 of UEs in the RRC_IDLE/INACTIVE state, it may be predetermined that repeated transmission in frequency resources is not supported.

After repeatedly receiving signals 609, 610, and 611 through radio 1 601 of the UE, it is necessary to determine whether the signals are repeated transmitted signals or a combination of other signals transmitted independently. To this end, the UE needs to know in advance when signals are transmitted. Information regarding repeated transmission may be explicitly configured for the UE by the gNB, or may be implicitly inferred from configured information. Examples of configuration methods for distinguishing whether signals received by radio 1 610 are repeated transmitted signals or not will be described below:
Method 1: the gNB may configure the interval X 612 between the timepoint of transmission of the first signal 609 and repeated transmitted signals 610 and 611 thereafter, and the number 603 of repeated transmissions, for the UE. This information may be directly provided to the UE from the gNB, or indirectly acquired by using information, such as the UE's unique ID. Specifically, the timepoint of transmission of the first signal may be determined at the subframe or slot or symbol level, and may be indicated or acquired as an offset value with regard to another timepoint determined previously. For example, the timepoint of transmission of the first signal may be given as an offset value with regard to the timepoint at which data 608 is transmitted/received. In case that a DRX configuration has previously been given to the UE, the timepoint of transmission of the first signal may be inferred with reference to the starting point of the DRX on-duration. The absolute value of the offset value may be configured by the gNB, or an offset value configured according to the UE's unique ID may be configured differently for each UE. In addition, the offset may be configured with reference to the last transmitted signal 611 in the repeated transmission, not the first signal 609. In this case, the UE may infer the timepoint of transmission of previous signals 609 and 610 from the value of X 612. Meanwhile, in a case in which X 612 is not configured by the gNB or is not determined in advance, repeated transmitted signals 609, 610, and 611 may be transmitted consecutively without a separate interval (that is, with no gap between signals). Alternatively, the timepoint of reception of repeated transmitted signals may be explicitly configured at the slot or symbol level, or an offset value regarding each signal may be designated separately.
Method 2: in case that a monitoring window in which radio 1 601 may receive signals transmitted from the gNB and timepoints at which signals may be transmitted in the monitoring window are predefined or configured by the gNB, the gNB may configure repeated transmission differently with regard to each monitoring window for the UE. The minimum information necessary to configure each monitoring window of radio 1 601 may include at least one of the following examples, and the information may be configured for the UE by using an explicitly given method, an implicitly given method, or both.
Monitoring window starting point: a timepoint at which signal detection starts such that radio 1 601 can determine whether signals have been transmitted from the gNB. The same may be given explicitly as in the case of configuring the timepoint of transmission of the first signal 609 in method 1 described above, or may be given as an offset value with regard to another timepoint configured in advance.
Monitoring window's length: a period of time for which signal detection by radio 1 601 continues. If the time corresponding to the length elapses from the monitoring window starting point, radio 1 601 of the UE does not perform signal detection until the next monitoring window starts.
Signal transmission timepoint in monitoring window: a timepoint at which signals may be transmitted in a monitoring window, and the smallest unit configurable may be a symbol unit. The gNB transmits signals to radio 1 601 only when there is information 608 to be transmitted/received by radio 2 602, and the UE thus is unaware whether the gNB will transmit signals at a transmission timepoint in the monitoring window. Therefore, the UE must try receiving signals at all timepoints of signal transmission and then determine whether signals have been transmitted from the gNB. For example, the smaller the interval between signal transmission timepoints, the more signal detection attempts are made in the monitoring window. To the contrary, if only one signal transmission timepoint is configured (or if a signal is transmitted only once), the UE may determine that there is no repeated signal transmission and may attempt signal detection only once. As an example, if a signal transmission timepoint in a monitoring window is configured to be the first OFDM symbol in a slot of the monitoring window, and if repeated transmission is configured for the monitoring window, signals transmitted in all first OFDM symbols of slots belonging to the monitoring window may be considered as being transmitted repeatedly.
In case that configurations of multiple monitoring windows having the above information are provided to UEs, each UE may determine whether a signal is transmitted repeatedly according to the configuration of the corresponding monitoring window. The number of monitoring windows configured for each UE, or the detailed configuration parameter value, may be configured differently according to the UE's RRC state, or may be configured in a cell-specific, group-specific, or UE-specific manner. In addition, the type of signals (for example, sequence ID, such as UE ID) that the UE needs to detect in respective monitoring windows may vary.
Method 3: method 3 is related to a case in which, although monitoring window is configured similarly to method 2, multiple pieces of repeated transmission information are configured for one monitoring window. In method 3, the following information may be additionally considered in addition to each monitoring window configuration in method 2:
Repeated transmission interval: an interval in which signals may be transmitted repeatedly in a monitoring window. A timepoint at which repeated transmission starts and an interval in which repeated transmission is maintained are configured. All signals transmitted in the interval are considered as being transmitted repeatedly. Multiple repeated transmission intervals may be configured in one monitoring window, and each repeated transmission interval may have a different configuration. For example, the signal transmission timepoint in the monitoring window and the signal transmission timepoint in each repeated transmission interval may differ. In addition, repeated transmission intervals may be configured to appear periodically in the monitoring window. The UE considers that, with regard to an interval not configured as a repeated transmission interval, signals transmitted from the gNB are not transmitted repeatedly. For example, the UE may determine (or assume) that signals are repeated only in repeated transmission intervals in the monitoring window, and may not expect that signals will be repeated in intervals other than the repeated transmission intervals in the monitoring window.

Although the above example has been described based on a configuration for repeated transmission in time resources, an additional configuration parameter for repeated transmission in frequency resources may be included and configured.

As described above, when the UE knows which signal is transmitted repeatedly, the UE's operations for detecting signals transmitted repeatedly may be divided into two. In the first signal detection operation, in case that radio 1 601 has detected signals in a repeated transmission interval, and if at least one signal is received, radio 1 601 may determine that a WUS has been received, and may send a trigger 604 signal to radio 2 602. For example, radio 1 601 may independently perform an operation of detecting signals 609, 610, and 611 transmitted repeatedly N 603 times. For example, assuming that a transmitted signal is an on-off keying (OOK) signal, whether on or off is determined with reference to the average power during one pulse interval of a received signal. When calculating the average power, whether on or off may be determined with reference to a signal transmitted once.

In the second signal detection operation, when assessing the result of signals detected in a repeated transmission interval, radio 1 601 assesses the same not with reference to one signal, but with reference to N repeated signals 603. For example, assuming that an OOK signal is transmitted repeatedly, radio 1 601 may not determine whether a specific pulse is on or off with reference to the average power of the first transmitted signal, but radio 1 601 may determine whether the pulse indicates on or off after calculating the entire average power based on the average power of signals transmitted later as well.

As another example, assuming that a transmitted signal is designed based on a specific sequence, radio 1 601 may determine whether the signal has been transmitted by sampling a received signal, calculating the cross-correlation coefficient with the coefficient of the signal to be received by radio 1 601, and determining whether the calculation result exceeds a threshold. In the case of the first operation, radio 1 601 may calculate the threshold each time a signal is received, and may confirm signal detection if the threshold is exceeded even once independently with regard to each calculated threshold. In the case of the second operation, radio 1 601 may calculate the average of respective thresholds received repeatedly so as to finally determine a signal has been transmitted. The second operation may be applied to a case in which repeated signal transmission by the gNB is guaranteed in an interval in which repeated transmission is possible. For example, the second operation may be valid if signal transmission by the gNB is guaranteed at all possible transmission timepoints of a repeated transmission interval, but only the first signal detection operation may be valid if the gNB performs repeated transmission only in a part of the entire repeated transmission interval for a specific reason (for example, when using the same to repeated transmit signals for other UEs, or if traffic has occurred in the middle of a repeated transmission interval, and signals are transmitted repeatedly only in the remaining repeated transmission interval). In the case of the first signal detection operation, the MDR of signals may be reduced, but the rate of erroneous detection of signals of other UEs unrelated to the corresponding signal may increase.

Meanwhile, information 608 that radio 2 602 of the UE may transmit/receive may be configured statically or dynamically. Specifically, referring to operations of RRC_IDLE/INACTIVE UEs in the current 5G systems, timepoints at which paging-related information (for example, paging PDCCH/PDSCH) is received periodically are configured for the UE, based on unique IDs, and the period during which UEs receive paging information is referred to as a DRX cycle.

The monitoring window of radio 1 601 may be configured according to the offset based on a statically configured timepoint at which paging-related information is received. In addition, the number of pieces of information 608 which may be received in one DRX cycle is fixed to one in this case. Therefore, even if a UE receives the same signal multiple times in one DRX cycle, radio 1 601 may not independently trigger (604) radio 2 602, but may trigger the same only once based on the timepoint at which radio 2 602 needs to receive information 608. For example, if radio 2 602 needs to receive information 608, the gNB may perform repeated transmission with regard to multiple signal transmission timepoints in a monitoring window. If the UE independently detects signals with regard to the multiple signal transmission timepoints, the UE may operate correctly without unnecessarily consuming power, even without being informed of the repeated transmission. Therefore, if the timepoint at which radio 2 602 transmits/receives information 608 is configures statically and periodically, and even if radio 1 601 has detected signals multiple times, the process of triggering (604) radio 2 602 may be performed only once within a predetermined period. However, with regard to a case in which the number of repeated transmissions contains specific information as in Table 8, the UE may operate according to the repeated transmission-related configuration and acquire specific information included therein in advance, and the UE may accordingly perform the following procedure. Specifically, assuming that repeated transmission is configured according to Table 8 and method 2 described above, the number of repeated transmissions of monitoring window 1 configured for radio 1 601 of the UE is 1, the number of repeated transmissions of monitoring window 2 is configured to be 3, and radio 1 601 has received a signal in monitoring window 1, then radio 1 601 may consider that the received signal is a signal for system information update, and may instantly perform system information update without additional paging PDCCH/PDSCH reception by radio 2 602. In addition, in case that radio 1 601 has received a signal in monitoring window 2, radio 1 601 may then consider that the received signal is information requesting RRC connection and may instantly attempt RRC connection without additional paging PDCCH/PDSCH reception by radio 2 602. However, even if radio 1 601 has received signals in both monitoring windows 1 and 2 in one DRX cycle, radio 1 601 may perform the operation of triggering (604) radio 2 602 only once in one DRX cycle in a static situation in which the information transmission/reception timepoint is repeated in each DRX cycle. However, in connection with operations performed after radio 2 602 reaches an active state, that is, information 608 receiving process, system information update and RRC connection attempt may be performed respectively as signals are received in both monitoring windows 1 and 2.

One of advantages obtainable when signals are received through radio 1 601 is that, together with power saving, the delay time during information transmission/reception may be reduced. Specifically, if the gNB transmits a signal to radio 1 601 the moment information 608 to be transmitted/received by radio 2 602 of the UE occurs, and in case that radio 1 601 triggers (604) radio 2 602 upon detecting the signal, radio 2 602 may instantly receive information, thereby reducing the time taken to transmit/receive the information 608. However, in order to enable such an operation, the timepoint at which radio 2 602 receives information 608 needs to be controlled dynamically, based on the timepoint at which radio 1 601 receives a signal. Particularly, the longer the monitoring window, and the smaller the number of repeated transmissions, the shorter time may take to transmit/receive information.

For example, compared with a static paging occasion (PO) operation in which a DRX cycle is configured such that a paging PDCCH/PDSCH is received periodically, the time taken to transmit/receive information may be shorter in the case of a dynamic PO operation in which radio 1 601 detects a signal according to a monitoring window regardless of the DRX cycle, triggers (604) radio 2 602 immediately after receiving a signal, and performs an operation of receiving a paging PDCCH/PDSCH or performs a preconfigured operation according to the type of received signal. In addition, the time taken to transmit/receive information may be further reduced if radio 1 601 always detects signals transmitted by the gNB without a monitoring window.

The difference between dynamically transmitting/receiving information 608 and statically transmitting/receiving information may be distinguished according to whether the timepoint at which radio 2 602 receives information 608 is configured with reference to the timepoint at which radio 1 601 receives a signal. For example, if the timepoint of transmission/reception by radio 2 602 is determined after a preconfigured specific time offset after the timepoint at which radio 1 601 has received a signal, this corresponds to a dynamic information transmission/reception operation. To the contrary, if the timepoint at which radio 2 602 receives data or information 608 is configured periodically through another scheme (for example, unique UE ID), this corresponds to a static information transmission/reception operation. However, in the case of dynamically transmitting/receiving information, there is a restriction on the method for configuring the monitoring window of radio 1 601, or the method for configuring repeated transmission. As in the example given above, in such a situation, it is impossible to use a configuration method of determining the timepoint at which radio 1 601 starts signal detection by using a given offset value with regard to the timepoint at which data or information 608 is transmitted/received. Therefore, if dynamic information transmission/reception is configured for radio 2 602, a method may be predefined such that the gNB configures a subframe/slot/symbol index in which a monitoring window is started, or the starting point of the monitoring window is inferred through preconfigured different information (for example, UE ID). As another method, the monitoring window may be configured with reference to a timepoint other than the timepoint at which data is transmitted/received. For example, a timepoint spaced apart a preconfigured offset from a slot in which an SSB having a specific index is transmitted may be the timepoint at which the monitoring window or signal's repeated transmission is started.

Examples of UE operations possible when a configuration (for example, dynamic PO) in which radio 2 602 dynamically transmits/receives information and a configuration in which signals received by radio 1 601 are transmitted repeatedly are simultaneously given to the UE, as described above, are as follows:
Operation 1: in case that dynamic information transmission/reception is configured, radio 1 601 considered that signals for radio 1 601 are not transmitted repeatedly from the gNB. For example, radio 1 601 may not expect repeated transmission of signals and may operate with a higher priority assigned to dynamic information transmission/reception than a configuration regarding repeated transmission. Therefore, radio 1 601 may detect signals likely to be transmitted from the gNB at a signal transmission timepoint in a monitoring window and, if signals are detected at least once, may trigger (604) radio 2 602.
Operation 2: in a case in which there is an interval for which repeated transmission is configured, radio 2 602 dynamically receives (608) information with reference to a timepoint at which the interval for which repeated transmission is configured has ended. For example, if a repeated transmission operation is configured with regard to each monitoring window (repeated transmission configuration method 2 described above), and if radio 1 601 has detected a signal during one monitoring window, radio 2 602 dynamically receives (608) information after a specific offset with reference to a timepoint at which the monitoring window has ended, or a timepoint at which the last repeatedly transmitted signal has been received. If there is no signal detected by radio 1 601 during a monitoring window, radio 2 602 may maintain an off state 605 until the next monitoring window. In case that multiple repeated transmission configurations exist in one monitoring window (that is, repeated transmission configuration 3 described above), radio 2 602 may dynamically receive (608) information each time one repeated transmission is ended.
Operation 3: a dynamic information reception timepoint may be determined with reference to a timepoint at which one monitoring window is ended, or a timepoint of transmission of the last signal configured in the monitoring window. This operation may be identical to operation 2 described above with regard to a case in which repeated transmission is configured for each monitoring window (repeated transmission configuration method 2 described above). However, in case that multiple repeated transmission configurations exist in one monitoring window (repeated transmission configuration 3 described above), the same is distinguished from operation 2. Specifically, the timepoint to perform dynamic information reception may be determined with reference to a timepoint at which one monitoring window is ended, or the last timepoint of reception of a signal in one monitoring window. In case that multiple signals distinguished from each other are transmitted in one monitoring window, and in case that a signal for a PWS in Table 8, for example, and signals indicating that RRC connection is to be made are received, respectively, radio 2 602 may successively perform corresponding operations with regard to respective signals with reference to a timepoint at which dynamic information transmission/reception is performed. Alternatively, if an offset value preconfigured with regard to radio 2 602 is configured differently for each repeated transmission configuration, radio 2 602 may perform operations corresponding to different timepoints, respectively. Alternatively, the dynamic information reception timepoint may be determined with reference to the time of reception of the last signal among respective signals received repeatedly, instead of configuring the same with reference to the timepoint at which the monitoring window is ended identically. According to operation 3, if the same transmitted/received configuration exists multiple times in one monitoring window, and in case that a repeatedly transmitted signal is detected multiple times in the corresponding interval (for example, if there are a total of three intervals in which repeated transmission occurs twice in one monitoring window, and if signals are received in two intervals among the same), radio 2 602 may consider that dynamic information transmission/reception is performed only once, not multiple times.

After radio 1 601 has detected a signal and has triggered (604) radio 2 602, the monitoring window of radio 1 601 may appear while radio 2 602 maintains an on state 606. In case that static information transmission/reception has been configured, radio 1 601 may not expect that monitoring windows will overlap while radio 2 602 maintains an on state 606, or may expect or assume that, even if monitoring windows overlap, a signal for radio 1 601 will not be received from the gNB. This is because, even if a signal for switching radio 2 602 to an on state 606 at the next information transmission/reception timepoint is received in a monitoring window started after the on state 606 is ended, there is no difference in the UE's information transmission/reception performance. To the contrary, a larger gain may be obtained because radio 1 601 performs no signal detection operation and thus reduces power consumption, or because radio 1 601 performs another operation (for example, channel quality measurement).

Meanwhile, if dynamic information transmission/reception is configured, the information transmission/reception timepoint is configured with reference to the timepoint at which radio 1 601 has received a signal. Therefore, even if radio 2 602 has been triggered (604) by radio 1 601 and thus switched to the on state 606, radio 1 601 may perform an operation of detecting signals received from the gNB according to a configured monitoring window. Therefore, if radio 1 601 receives a new signal while radio 2 602 of the UE is performing a specific operation according to a signal received by radio 1 601 after switching to the on state 606, the UE may consider that there is more information to be transmitted/received by radio 2 602, and may receive information while maintaining the on state 606, with reference to the timepoint of reception of a signal detected later, until the timepoint at which information indicated by the corresponding signal is transmitted/received. Signal reception, as described herein, assumes that signals for which repeated transmission is configured are one signal. UE operations when dynamic information transmission and repeated transmission of a signal for radio 1 are configured simultaneously are configured or defined in advance. Therefore, there will be no separate description regarding a case in which the UE switches the on state multiple times due to a repeatedly transmitted signal, or attempts information transmission/reception multiple times.

In addition, a case in which information is dynamically transmitted/received to one UE according to the type of transmitted/received information and a case in which information is transmitted/received statically may be configured together. For example, dynamic information transmission/reception and monitoring windows of radio 1 corresponding thereto may be configured with regard to information A, and static information transmission/reception and monitoring windows of radio 1 corresponding thereto may be configured with regard to information B.

### Second Embodiment

In the second embodiment of the disclosure, methods for designing a WUS such that the UE can directly know whether no WUS detection has occurred or not.

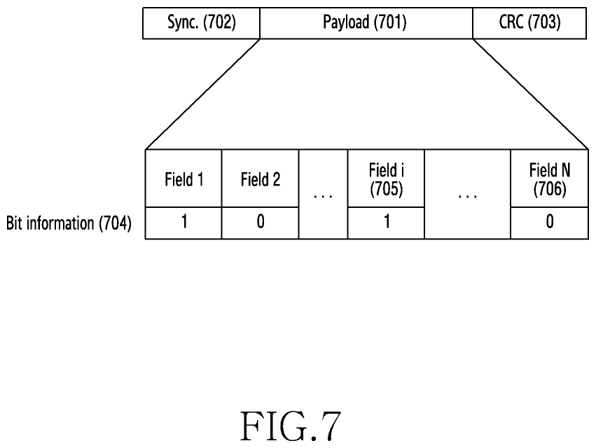

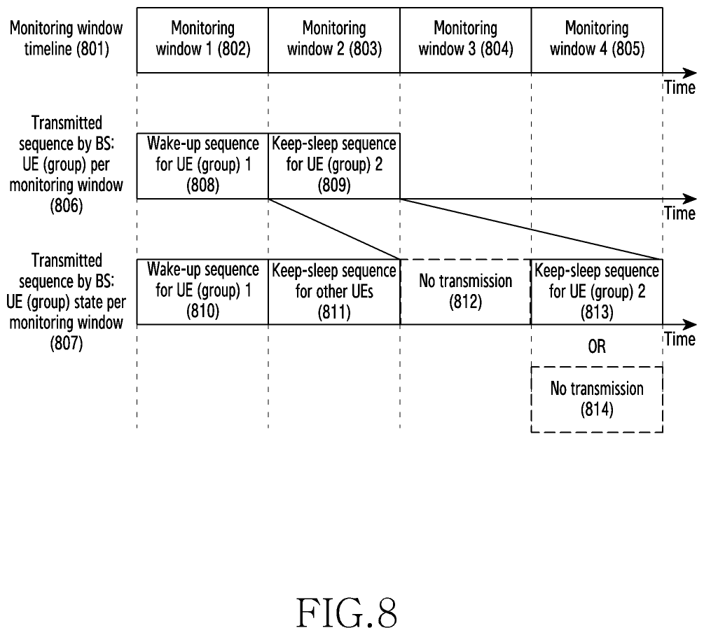

In the first method, if a timepoint at which the UE needs to receive a WUS is configured, all information for the WUS to indicate whether the UE wakes up the main radio may be included. For example, if a specific UE or a specific UE group does not have to wake up, the gNB transmits a WUS including information indicating that the corresponding UEs do not have to wake up. Information basically included in a WUS may include information (for example, UE-(group) wake-up ID) regarding which UE (group) has to wake up among UEs or a UE group having the same WUS monitoring window. Furthermore, information indicating that a specific UE does not have to wake up, that is, information indicating that the main radio of a specific UE may further maintain a sleep mode, may also be transferred through the WUS. When a WUS is designed based on a message and when a WUS is designed based on a sequence, in the embodiment of the disclosure, a method for designing a WUS so as to include information indicating whether a specific UE (group) has to wake up will be described with reference to FIGS. 7 and 8.

FIG. 7 illustrates a method for designing a WUS, based on a message, such that WUS information include information indicating whether a specific UE has to wake up according to an embodiment of the disclosure.

Referring to FIG. 7, a message-based WUS may be designed such that information to be transferred through the WUS (for example, information regarding wake-up of a specific UE or UE group) is converted to bits through an encoding process and then transferred through the payload 701 portion. There is a high possibility that a WUS will be designed to be detected through a receiver having a simple structure. Therefore, there is a high possibility that a message-based WUS will be transmitted based on OOK or frequency shift keying (FSK) modulation, instead of being transmitted through OFDM modulation as in an OFDM signal used in a legacy NR system, and a simple coding technique (for example, Manchester coding) may be applied as the encoding technique used for the payload 701, instead of a complicated type. In addition, a synchronization signal 702 may be transmitted together with the payload 701 in order to reduce errors in the time or frequency domain before decoding bit information corresponding to the payload 701, and a CRC bit 703 may be transmitted together with the payload 701 in order to reduce the rate of erroneous detection such that UEs identify whether the transmitted WUS is directed to the UEs.

The structure of the message-based WUS in FIG. 7 is only an example, and the structure or order of the message may be implemented differently from the illustrated embodiment. The message may also be configured to include only some of the three portions 701, 702, and 703 in the message-based WUS structure. The message may also be configured to have an added portion (not illustrates) for performing another function. In addition, respective portions may be mapped to time and frequency resources in various methods. Specifically, information regarding the synchronization signal, payload, and CRC bit may be mapped to multiple OFDM symbols in the same frequency resource and then transmitted, or may be divided and transmitted in different frequency resources, respectively. However, when divided and transmitted in different frequency resources, the receiver needs to be capable of distinguishing signals transmitted in different frequency resources, respectively.

Referring to FIG. 7, the payload 701 includes bit information 704. For example, the message-based WUS is configured such that information to be transferred through the WUS is encoded to bits. The bit information 704 may indicate a specific ID (for example, wake-up UE-(group) ID) or may indicate which UE (group) has to wake up and which UE (group) is allowed to keep operating the main radio in a sleep mode. For example, assuming that field i 705 in FIG. 7 indicates the third field, and field N 706 indicates the fourth field, the payload in FIG. 7 may be considered as corresponding to a total of four bits, and bit information transferred through the WUS is “1010”. If the bit information indicates the wake-up ID of a specific UE, the UE may determine that the WUS corresponds to a UE having a wake-up ID of binary number “1010” or decimal number “10”, and UEs having wake-up IDs different from the received wake-up ID may maintain the sleep mode without waking up the main radio. In this method, the number of UEs associated with one WUS may be increased so as to reduce the amount of resources necessary to transmit the WUS. Referring to the above example, if N is 4, UEs having a total of 2\hat{ }4=16 wake-up IDs receive the same WUS. However, if UEs have failed to detected the WUS, there is no knowing whether the gNB has transmitted no WUS because there is no UE to wake up among the same, or the WUS has not been detected due to a detection error in the CRC identification process. Therefore, it may be considered to configure one (for example, “0000”) of the 16 pieces of bit information as the ID of a case in which no UE wakes up. The gNB then has to transmit the WUS in a predetermined resource. If UEs (UE groups) have failed to detect the WUS in the configured resource, they may determine that no WUS has been detected, and may wake up the main radio, thereby reducing the influence of no WUS detection.

Another method in which a UE can directly know whether the UE has to wake up through a WUS is to design the WUS such that each field in FIG. 7 (corresponding bit information) indicates whether UEs have to wake up. Referring to FIG. 7, the bit information 704 includes a total of N fields 706, and N UEs or UE groups thus receive the same WUS. Among the N UEs (UE groups), the i^{th} UE group identifies only bit information corresponding to field i 705. For example, assuming that bit information “1” indicates the main radio's wake-up information, and “0” indicates information instructing to maintain the main radio's sleep state (or vice versa), UEs (or UE groups) corresponding to the field of bit information 1 (or 0) may wake up the main radio, and UEs (or UE groups) corresponding to the field of bit information 0 (or 1) may maintain the main radio's sleep state. If a WUS is designed in this method, the gNB may preconfigure frequency and time resources to transmit the WUS for the N UEs (or UE groups), and respective UEs (or UE groups) may periodically receive the WUS in the resources. In addition, the proposed scheme is advantageous in that, if multiple UEs (or UE groups) among the N UEs (or UE groups) have to wake up the main radio, multiple UEs (or UE groups) may be woken up by transmitting one WUS. However, the number of fields is limited to N, and if more UEs (or UE groups) need to be distinguished, the bit number of the payload 701 may be increased, or different resources may be configured to respective UEs (or UE groups) to transmit multiple WUSs in various frequency and time resources. If there is no need to wake up N UEs (or UE groups) all, the gNB may not transmit the WUS. However, if the gNB transmits no WUS, UEs supposed to receive the WUS may not identify whether no WUS is transmitted because there is no UE to wake up, or an error has occurred when the UEs receive the WUS. Therefore, in order to reduce the influence of no WUS detection by UEs in the same manner as in the previous example, the gNB may always transmit a WUS even if there is no UE to wake up.

FIG. 8 illustrates a method for designing a WUS, based on a sequence, such that resources for transmitting a sequence that constitutes the WUS, or a WUS sequence, include information indicating whether a specific UE has to wake up according to an embodiment of the disclosure. Prior to transmitting a sequence-based WUS, respective UEs (or UE groups) are configured regarding which sequence is to be detected, and have time and frequency resources configured to transmit the WUS, as in the case of the message-based WUS. A sequence configured in a time resource may be transmitted through OOK modulation, or a configured sequence may be mapped to each subcarrier in a frequency resource and then transmitted through OFDM modulation. The WUS receiver may sample received signals, may calculate cross correlation in time resources, thereby detecting the through OOK modulation, or may calculate FFT so as to detect the WUS in frequency resources.

FIG. 8 illustrates a method for transmitting a WUS such that, regardless of the WUS modulation scheme, when a sequence is configured as a WUS for a specific UE (group), the UE can know whether a WUS detection error has occurred.

Referring to FIG. 8, the gNB may configure, for a UE (group), regarding in which monitoring window a WUS is to be received, among WUS monitoring windows 801, 802, 803, 804, and 805. The gNB may configure a WUS monitoring window in one of the following two methods such that the UE can know whether a WUS detection error has occurred. In connection with configuring a monitoring window, the repeated transmission-related configuration handled in the first embodiment may be applied in combination with the following configuration, but the embodiment will be described assuming that WUS repeated transmission is not applied.
Monitoring window configuration method 1 806: corresponds to a case in which one monitoring window is configured for each UE (group). In case that there is a UE which needs to wake up its main radio among UEs for which the monitoring windows are configured, the gNB transmits a wake-up sequence 808 for the UE. In case that there is no UE which needs to wake up its main radio, the gNB transmits a keep-sleep sequence 809 meaning that the main radio-s sleep mode is to be maintained. For example, the gNB transmits one of a wake-up sequence and a keep-sleep sequence for a specific UE in all monitoring windows for the WUS. If only one UE is configured for one monitoring window, the corresponding operation may proceed UE-specifically. If there are multiple UEs (not one UE) having the same monitoring window configured therefor, the multiple UEs receive the same sequence and thus may operate as a group-based WUS. For example, if the main radio of even one UE in a group has to wake up, the gNB transmits a wake-up sequence for the UE group in the corresponding monitoring window. According to this scheme, the gNB transmits a WUS for each group, if the main radio of a specific UE in a group has to wake up, the main radio of other UEs in the same group also wake up, thereby increasing power consumption. Therefore, it is also possible to consider another method wherein UE groups having the same monitoring window configured therefor have different wake-up sequences configured therefor, respectively. For example, referring to FIG. 8, different wake-up sequences may be configured for UE groups or UEs corresponding to monitoring window 1 802, respectively, and if the gNB wants to wake up UE 1 among the same, the gNB may transmit a wake-up sequence 808 for UE 1. If the gNB has no need to wake up the main radio of any UE among UEs having a specific monitoring window configured therefor, like monitoring window 2 803 in FIG. 8, the gNB transmits a keep-sleep sequence 809 configured commonly for UEs having the monitoring window 2 configured therefor. If the gNB transmits a wake-up sequence for a specific UE (for example, in the case of 808), other UEs having the same monitoring window configured therefor may determine that a WUS detection error has occurred because both the wake-up sequence and the keep-sleep sequence configured for the UEs have not been detected. Therefore, the WUS receiver of a UE may attempt to detect not only the sequence configured therefor, but also a wake-up sequence which may be configured for another UE, thereby determining whether a WUS for another UE has been transmitted or a WUS detection error has occurred. If the WUR identifies that a sequence of any UE has not been transmitted, the UE may determine that WUS detection error has occurred, and may wake up the main radio and then identify whether there is information to be transmitted/received. If there is one type of wake-up sequence which may be transmitted in one monitoring window, one type of wake-up sequence and one type of keep-sleep sequence may be transmitted in one monitoring window, respectively. Therefore, a total of two types of sequences may be transmitted in one monitoring window. If a wake-up sequence for M UEs is distinguished, a total of (M+1) types of sequences may be transmitted. The WUR is already aware of what sequences may be transmitted in the same monitoring window, and needs to be able to detect the sequences. For example, the UE's WUR may have a buffer capable of temporarily storing coefficient values corresponding to respective sequences and received signals, or may have a cross-correlator capable of simultaneously calculating cross-correlation values regarding all sequences.
Monitoring window configuration method 2 807: corresponds to a case in which one monitoring window is configured per the state of each UE (group). Operations of each UE (group) may be divided into various types, but it will be assumed in the description with reference to FIG. 8 that they are divided into two states. A UE's state may be divided into a wake-up state and a keep-sleep state. As described above, according to monitoring window configuration method 1, multiple UEs are assigned to the same monitoring window, but the wake-up sequence for each UE may differ. Therefore, the WUR has to detect all sequence candidates to know whether a WUS is transmitted or not, and this may increase the WUR's complexity. Therefore, by distinguishing what operation each UE has to perform according to not only the type of a transmitted sequence, but also the location of the monitoring window in which the sequence is transmitted, each UE's WUR may determine whether a WUS detection error occurs or not by detecting only two types of sequences even if the gNB has configured the same monitoring window for multiple UEs.

Referring to reference numeral 807 in FIG. 8, monitoring window 1 802 and monitoring window 2 803 are configured for specific UEs, and the gNB transmits a wake-up sequence 810 for a UE, the ID of which is 1, in monitoring window 1 in order to wake up the UE (or UE group), the ID of which is 1, among the UEs. If there are multiple UEs having the same wake-up sequence configured therefor, a wake-up sequence 810 for UE group 1 is transmitted, and UE 1 may be included in UE group 1. For example, in the described example, monitoring window 1 refers to an interval in which a wake-up sequence for a specific UE (group) is transmitted. In addition, the gNB transmits a keep-sleep sequence 811 for UE, the main radio of which may maintain a sleep mode, among UEs having the same monitoring window configured therefor. For example, monitoring window 2 refers to an interval in which a keep-sleep sequence is transmitted. Thereforfe, a total of two monitoring windows are configured, and a UE may determine in which state the UE has to operate, between a wake-up state and a keep-sleep state, according to the sequence received in each interval.

If a specific UE's WUR has detected a configured wake-up sequence in a monitoring window indicating a wake-up state and has detected a keep-sleep sequence in a monitoring window indicating keep-sleep state, the UE may know that the gNB wants to wake up only the main radio of the UE among multiple UEs, and may expect that the main radio will perform a UE-specific operation or will receive UE-specific information. On the other hand, if a specific UE's WUR has detected no configured wake-up sequence in a monitoring window indicating a wake-up state and has detected a keep-sleep sequence in a monitoring window indicating keep-sleep state, the UE may know that the gNB wants to wake up another UE having the same monitoring window configured therefor, and may operate such that its main radio maintains the sleep mode.

As illustrated in FIG. 8, there are other UEs (UE group 2 in FIG. 8) having the same monitoring window configured therefor in monitoring window 3 804 and monitoring window 4 805 as well, but the gNB may want to wake up none of the UEs. If there is no UE to wake up among UEs having specific monitoring windows configured therefor, the gNB transmits no sequence 812 in monitoring window 3 804 for transmitting a wake-up sequence. However, the gNB may transmit a keep-sleep sequence 813 for UEs having the corresponding intervals configured therefor in monitoring window 4 805 such that the main radio of UEs having monitoring windows 3 and 4 configured therefor maintains the sleep mode. The corresponding operation may require many resources in that multiple monitoring windows are configured, but is advantageous in that the same monitoring window may be configured for multiple UEs while reducing the complexity of the WUR of UEs.

Furthermore, if the gNB has to wake up the main radio of all UEs in the same monitoring window (for example, cell-specific information transmission), the gNB may indicate a cell-specific wake-up without configuring a monitoring window for a separate sequence or a cell-specific WUS, or successively transmitting a wake-up sequence for all UEs. For example, if the gNB transmits no sequence in two monitoring windows configured for each UE, the corresponding operation may guide UEs to conduct a cell-specific wake-up. This is because, if UEs detect no sequence in both a monitoring window in which a wake-up sequence is transmitted and a monitoring window in which a keep-sleep sequence is transmitted, the UEs may confirm a WUS detection error, wake up the main radio, and exchange information with the gNB to know whether there is an operation to be performed by the UEs. Therefore, if a UE is configured to wake up the main radio in the case of a failure to receive a sequence transmitted in configured monitoring windows, or if the gNB needs cell-specific information transmission, and if the gNB does not transmit a signal 814 in specific monitoring windows intentionally in order to wake up all UEs, a cell-specific wake-up and a UE-specific wake-up may be indicated separately.

According to the second method, information transferred by a WUS includes information indicating what numbered WUS is transmitted. In this method, it is impossible to know whether there is a WUS detection error the moment a WUS is transmitted as in the first method, but when a WUS transmitted thereafter is receive, it may be recognized whether there is an intermediate WUS that has failed to be detected.

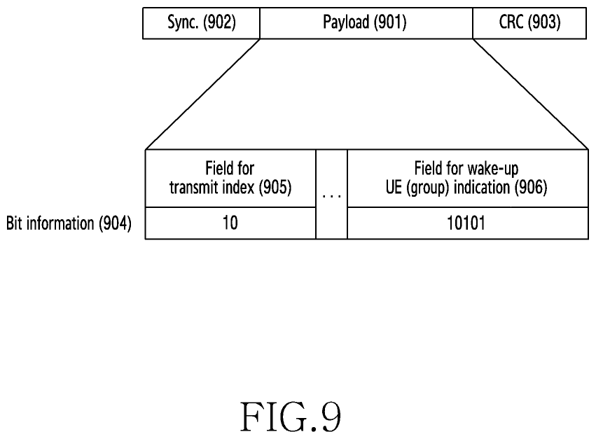

FIG. 9 illustrates a method for designing a WUS, based on a message, such that the WUS's transmission index information is included according to an embodiment of the disclosure.

Referring to FIG. 9, a message-based WUS's structure may be divided into a payload 901 portion for containing specific information, a portion 902 for synchronization, and a CRC bit transmission portion 903 for reducing the rate of erroneous detection. The payload 901 may include various pieces of information, and may basically include a field for a wake-up indication 906 indicating the main radio of which UE (group) is to be woken up. The gNB may transmit bit information 904 regarding the number of transmissions of the WUS through a field 905 for transmit index. For example, assuming that the corresponding field has a two-bit size, the number of transmissions of the WUS may be subjected to a modulo-4 operation and then contained in transmit index information. Then, 00 indicates the first transmission for the corresponding UE or UE group, 01 indicates the second transmission, 10 indicates the third transmission, 11 indicates the fourth transmission, and 00 again indicates the fifth transmission.

The transmit index value of a WUS may accumulate and increase each time respective WUSs for various UEs receiving the same WUS are transmitted. Each time a WUS for a specific UE is transmitted, the UE's transmit index value may be transmitted. For example, referring to FIG. 9, if “10101” in the wake-up indication field indicates a UE or a UE group, the wake-up ID of which is “10101”, the transmit index may be designed to increase each time a WUS for the UE (group) corresponding to “10101” is transmitted. For example, the gNB may irregularly transmit the transmit index value according to which UE is to be woken up by the WUS. However, if “10101” explicitly indicates whether the main radio of a specific UE (group) among five UEs (or UE groups) has to wake up or not, the transmit index may increase each time the WUS is transmitted. However, in the case of a WUS for indicating whether each UE (group) has to wake up, a UE may wake up the main radio if no WUS is detected. Therefore, the UE may confirm no WUS detection without having to identify the transmit index of the next WUS. In such a case, instead of being used to determine whether a WUS is detected or not, the transmit index may be used to determine whether a WUS is detected erroneously, or may be used to reduce the influence of power consumption due to erroneous detection by another UE when designed as a group-based WUS. Specifically, if the gNB has expected that a specific UE would conduct a specific behavior after receiving a WUS, but if no response is detected from the UE, another WUS may be transmitted. In such a case, the gNB maintains the same value of the transmit index (does not increase it). For example, when retransmitting a WUS, the gNB maintains the same value of the transmit index as that during the initial transmission. Accordingly, UEs which receive the same WUS and have the same wake-up ID may recognize that a WUS for other UEs has been retransmitted, and since the UEs have already woken up the main radio and identified information from the gNB when previously received a WUS, the UEs may not repeatedly wake up the main radio due to the retransmitted WUS. In addition, in a case in which the wake-up indication field indicates whether specific UE groups have to wake up through bits of “1” and “0”, a UE may not wake up erroneously, that is, although bit “1” for a specific UE has been transmitted to wake up the main radio, the UE recognizes the same as “0” due to an error in the bit decoding process. The gNB may then retransmit the WUS, and if the gNB maintains the same value of the transmit index, UEs which identify the same WUS and the same bit location may recognize that the WUS has the same usage as the previously transmitted WUS, and may maintain the main radio's sleep mode, thereby preventing unnecessary additional power consumption.

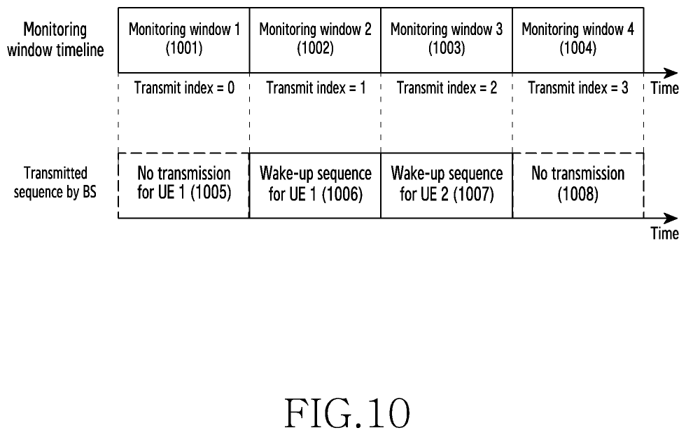

FIG. 10 illustrates a method for designing a WUS, based on a sequence, such that the WUS's transmission index information is included according to an embodiment of the disclosure.

Referring to FIG. 10, specifically, according to which monitoring window 1001, 1002, 1003, or 1004 is used to transmit a WUS, the sequence-based WUS may include different transmit index information.

Referring to FIG. 10, a total of four monitoring windows 1001, 1002, 1003, and 1004 are configured for a specific UE (group), and UEs may have a pre-configuration regarding which monitoring window indicates which transmit index. Thereafter, according to in which monitoring window the sequence of a specific UE (group) is detected, the UE may recognize during what numbered transmission the WUS has been received.

Similarly to the message-based WUS, when the gNB retransmits a WUS which a specific UE has filed to detect, the gNB may transmit the WUS in a monitoring window at the same location such that other UEs using the same sequence do not unnecessarily consume power due to the retransmitted WUS. In addition, it will be assumed that the gNB transmits a keep-sleep sequence 1006 for UE 1, the main radio of which has to wake up, only in the monitoring window 1002 corresponding to the transmit index among the monitoring windows, and the wake-up sequence is not transmitted 1008 in the remaining monitoring windows 1001, 1003, and 1004. In the assumed situations 1005, 1007, if the WUR detects the same wake-up sequence in two or more monitoring windows, the UE may then determine that erroneous WUS detection has occurred, and may wake up the main radio. However, a different wake-up sequence may be transmitted if a UE (UE 2 in FIG. 10) having a different wake-up sequence, for which the same monitoring window is configured to increase resource utilization, has a different transmit index (the case 1007 in FIG. 10). However, UE 1 will determine that no WUS has been transmitted because UE 1 detects only a wake-up sequence corresponding thereto in monitoring window 3 1003.

### Third Embodiment

In the third embodiment of the disclosure, UE operating methods capable of reducing the influence of erroneous detection and miss detection of a WUS will be described. The WUS transmitted from a gNB to a UE includes the example in the first and second embodiments of the disclosure, but is not limited thereto.

If the UE receives a WUS-related configuration from the gNB, and if an operation of receiving a WUS by utilizing the UE's WUR is activated, the WUR will attempt to detect a WUS periodically or continuously. The UE's WUR may not wake up the main radio and maintain the sleep state until the WUR detects a WUS, or until a separate specific condition is satisfied, thereby reducing power consumption. The influence of erroneous detection or miss detection of a WUS may be reduced through specific conditions configurable besides WUS reception.

The first UE operating condition is to reduce the influence of no WUS detection, based on a preconfigured timer. A timer related to operations of a WUS will hereinafter be referred to as a wake-up timer, and the specific name may vary. Specifically, if a UE's main radio switches to a sleep mode, the wake-up timer operates. If the UE's main radio never switches from the sleep mode to an activated mode until a time configured in the wake-up timer elapses (that is, until the wake-up timer expires) since the main radio has switched to the sleep mode, the UE's WUR may wake up the main radio and identify whether there is information that has failed to be received during the sleep mode. For example, an RRC_IDLE/INACTIVE UE may identify system information provided by the gNB and may then identify there is an updated portion in system information configured before the main radio has switched to the sleep mode. Alternatively, in order to identify whether there if information or the like, which has failed to be received because the UE has detected no WUS, the UE may request the gNB to provide WUS transfer information, paging information, or the like regarding the UE during the time of operation of the wake-up timer. In addition, if the UE has found that it has missed the previous WUS due to the transmit index described in the second embodiment of the disclosure, the UE may transmit a message to the gNB to request previous paging information or the like in order to wake up the main radio and to identify information that has failed to be received previously. If an RRC_CONNECTED UE cannot receive a retransmitted WUS due to a repeated WUS detection error, or has detected no cell-specific/group-specific WUS, the UE may likewise maintain the sleep mode until the wake-up timer expires, or may recognize that there is a previous detection error if a transmit index is transmitted. In such a case, in order to reduce the influence of the previously missed WUS, the UE may wake up the main radio and transmit a signal or a message to the gNB to request previously transmitted data information or WUS information. In addition, facts regarding WUS detection errors may be reported to the gNB, and the gNB may adjust whether the corresponding UE uses the WUS or not by evaluating WUS detection capability or the like regarding the corresponding channel. For example, if the state of a channel is deemed to be inappropriate for the WUR to receive a WUS during a WUS-based operation, the gNB may deactivate the WUS operation with regard to the corresponding UE or all UEs in the cell operated by the gNB. As another method, the UE may directly determine whether or not to use the WUS, based on facts regarding WUS detection errors. Particularly, an RRC_IDLE/INACTIVE UE is in a situation in which it is difficult to transmit a signal directly reported to the gNB, and the UE may thus independently determine whether or not to operate the WUS, based on the wake-up timer or the transmit index or the rate of erroneous detection that occurred after WUS reception. If the rate of erroneous detection and miss detection that occurred for a specific time exceeds a specific value, the UE may not receive the WUS or may transmit signaling or a message for identifying or requesting a job for identifying the WUS channel state from the gNB. After the main radio is woken up because the wake-up timer has expired through such a process, the UE may deactivate the WUS reception operation through the WUR by means of the gNB or as desired. Alternatively, the UE may switch the main radio back to the sleep mode and operate the WUR to return to the WUS receiving state. If the UE again receives the WUS through the WUR, the wake-up timer which has been initialized and stopped at the previous moment at which the main radio was woken up may again operate from the timepoint at which the main radio has switched to the sleep mode, and may repeat the above-described operations.

The second UE operating condition is as follows: when the UE's WUR assists channel state measurement or directly measures the channel state, and if there is a high probability that an erroneous detection will occur, based on the measured channel state, the UE may wake up the main radio, measure the channel state, and identify whether erroneous WUS detection has occurred. The operation of identifying whether a WUS detection error has occurred is similar to the above description regarding the first UE operating condition. Particularly, in the case of an RRC_IDLE/INACTIVE UE, the main radio has to periodically measure the cell channel state, and this is referred to as radio resource management (RRM) measurement. The UE has to perform RRM measurement at each predetermined period, and in order to reduce the frequency at which the main radio wakes up, a method in which the WUR performs a part of the RRM measurement process instead may be considered. For example, the WUR may perform RRM measurement, based on a specific signal received from the gNB, and if the same does not exceed a previously configured condition, the UE may wake up the main radio and perform double channel state identification through RRM measurement by the main radio. The description that the main radio is woken up for RRM measurement means that signal reception through the WUR is not efficient. Therefore, the UE may together perform operations, such as requesting the gNB to confirm whether there are WUSs and signals which have failed to be detected previously, or directly identifying system information.

### Fourth Embodiment

In the fourth embodiment of the disclosure, operations of a UE or a gNB for reducing the influence of WUS detection errors will be described. Information regarding a WUS configured by the gNB may include all or part of content in the embodiments described above, but is not limited thereto.

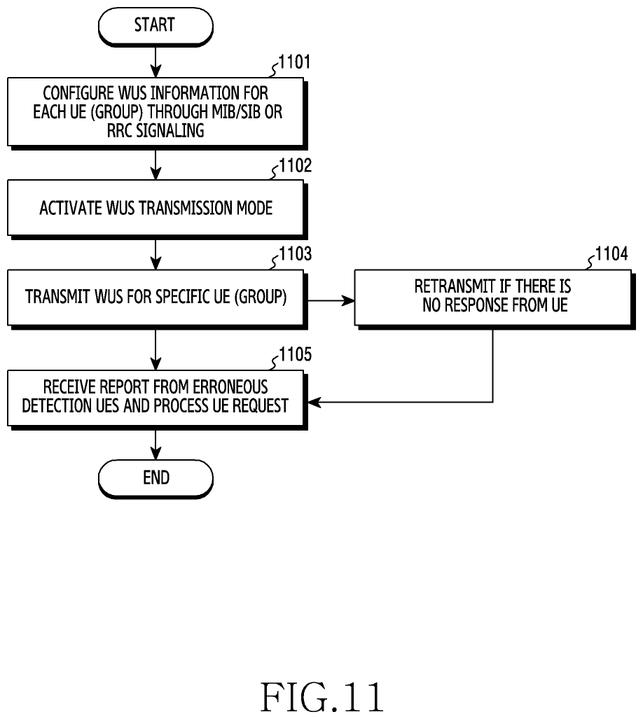

FIG. 11 is a flowchart illustrating operations of a gNB when an influence of erroneous WUS detection by UEs is to be reduced according to an embodiment of the disclosure.

Referring to FIG. 11, in operation 1101, the gNB has to provide UEs with information regarding whether a WUS is supported (or transmitted), such as a WUS is currently transmitted, or whether the gNB is capable of transmitting a WUS, through MIB or SIB. If a WUS is supported, the gNB accordingly provides various pieces of configuration information to UEs. For example, the gNB may provide UEs with configuration information regarding a monitoring window described above, a wake-up UE ID or a wake-up/keep-sleep sequence, information regarding repeated WUS transmission, a wake-up timer, and the like.

Even if the gNB is capable of transmitting a WUS, the gNB may turn off the WUS transmission mode. If the WUS transmission mode of the gNB is turned off, the operation is the same as that of a gNB which does not support the WUS, except that WUS-related information is provided to UEs. If the gNB wants to operate in the WUS transmission mode, the gNB activates the WUS and signals information indicating that the gNB will operate in the WUS transmission mode to the UE in operation 1102. The WUS transmission mode activation information may be related to a specific UE or UE group or related to a specific wake-up (group) ID. The WUS transmission mode activation information may include configuration information regarding WUS transmission described above. In addition, the configuration information may be information for updating preconfigured WUS configuration information.

If data traffic for a specific UE (group) operating in a WUS reception mode has occurred such that the gNB needs to wake up the corresponding UE (group), the gNB recognizes and transmits the WUS in operation 1103 and resource corresponding to the UE (group) to be woken up. If traffic for each of multiple UEs occurs, the gNB may determine the WUS to be transmitted first, based on the traffic occurrence order or priority.

The WUS transmitted by the gNB may request a specific UE to transmit specific information to the gNB. For example, if the gNB has expected to receive a UE's ACK signal after transmitting a WUS or to configure the UE's RRC connection, but if no response has been received from the UE, the gNB may retransmit the WUS to the UE. In order to redundant operations by UEs which have received the same WUS and thus woken up previously, the gNB may switch to and retransmit a UE-specific WUS for a UE which has not responded to a WUS previously transmitted group-specifically or cell-specifically, and may include the same transmit index as the initial transmission in the retransmitted WUS such that other UEs in the group are aware of retransmission.

There may be UEs which have woken up although there is no need to wake up after WUS transmission, and there may be UEs which have woken up through a wake-up timer due to a failure to detect the previously transmitted WUS. Alternatively, UEs may wake up if they can detect no WUS, assuming that they have been directly informed of whether a WUS has been transmitted. Corresponding UEs may perform an operation (in operation 1104) of receiving a signal from the gNB and determining whether the same has occurred normally, or identifying whether there is a WUS which has filed to be detected previously. In operation 1105, if the gNB has a request for previous WUS information or the like, the UE may transmit a signal containing content regarding previous WUS information to the corresponding UE (group). In addition, it may be determined whether to deactivate WUS/WUR operation at a specific UE (group) or cell level, based on reported information regarding the rate of erroneous WUS detection by UEs.

The disclosure is not limited by above descriptions made with reference to FIG. 11, which may be combined with at least some or all of the first embodiment of the disclosure, the second embodiment of the disclosure, and/or the third embodiment of the disclosure. The disclosure may also be performed by omitting each step in FIG. 11, by adding other steps, or by changing the order thereof.

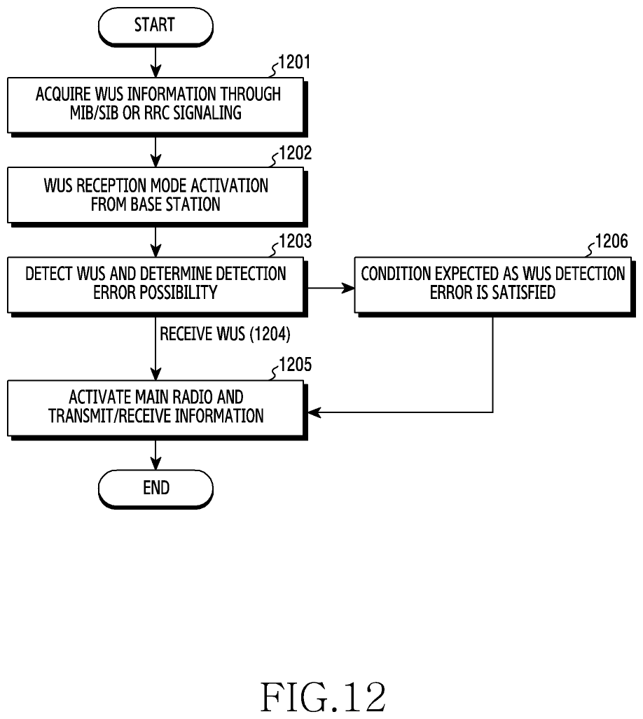

FIG. 12 is a flowchart illustrating operations of a UE when the influence of erroneous WUS detection is to be reduced according to an embodiment of the disclosure.

Referring to FIG. 12, in operation 1201, each UE may receive information regarding whether the gNB supports (or transmits) a WUS and other WUS transmission information through at last one of pieces of information predetermined by the initial access process or signaling or specifications. Particularly, a UE in an RRC_IDLE state may obtain WUS-related information through MIB and/or SIB and information detailed in specifications. A UE in an RRC_INACTIVE state may acquire MIB and/or SIB information WUS-related information configured in an RRC_CONNECTED state.

In operation 1202, if instructed by the gNB to activate the WUS reception mode, UEs switch the main radio to a sleep mode and start monitoring a WUS transmitted from the gNB through the WUR. If a wake-up timer is configured, UEs start operating the wake-up timer. In addition, the WUS monitoring resource and reception method are based on information acquired in operation 1201 and, unless otherwise indicated by the gNB, UEs consider that there is no change already-received WUS information. The WUS transmission mode activation information may be related to a specific UE or UE group or related to a specific UE. The WUS transmission mode activation information may include configuration information regarding WUS transmission described above. The configuration information may be information for updating preconfigured WUS configuration information.

In operation 1202, in case that a WUS reception mode is activated, and if information for WUS reception is confirmed, UEs periodically detect a WUS, based on configured WUS information in operation 1203. In addition, UEs may determine whether a WUS detection error has occurred concurrently with detecting a WUS. Regarding this, a past WUS detection error may be determined with reference to the above-described transmit index. In case that a WUS is used to inform whether UEs have to wake up, it may be determined whether a WUS to be transmitted at the corresponding WUS detection timepoint is detected erroneously or not. Alternatively, it may be determined whether there is a possibility of a detection error by identifying whether a specific condition described in the third embodiment has occurred through a wake-up timer or RRM measurement by the WUR.

In case that the UE's WUR succeeds (in operation 1204) in receiving a WUS in operation 1203, it may be determined that a WUS for the corresponding UE (group) has been transmitted, and the UE may wake up the main radio and receive information from the gNB in operation 1205. If the WUS has been received appropriately, there is data to be received from the gNB by the UE. However, if a UE has woken up by erroneously detecting a WUS for another UE, the UE may be aware of the fact that a WUS detection error has occurred. Therefore, the WUS detection error situation may be reported to the gNB or to the UE's upper layer so as to determine a following WUS and whether or not to activate the WUR.

If a detection error possibility is determined while detecting a WUS in operation 1203, that is, if a condition expected as a WUS detection error is satisfied (in operation 1206), UEs may perform operation 1205. For example, the following cases may be included: if a UE is supposed to receive one of a wake-up signal or a keep-sleep signal, and if no signal is received, or if an unexpected transmit index is received; if the wake-up timer expires; if WUR's RRM measurement value does not satisfy a specific condition; and the like. The UE may then activate the main radio and receive information from the gNB to know whether there is missed information, or request the gNB to provide information.

The disclosure is not limited by above descriptions made with reference to FIG. 12, which may be combined with at least some or all of the first embodiment of the disclosure, the second embodiment of the disclosure, and/or the third embodiment of the disclosure. The disclosure may also be performed by omitting each step in FIG. 12, by adding other steps, or by changing the order thereof.

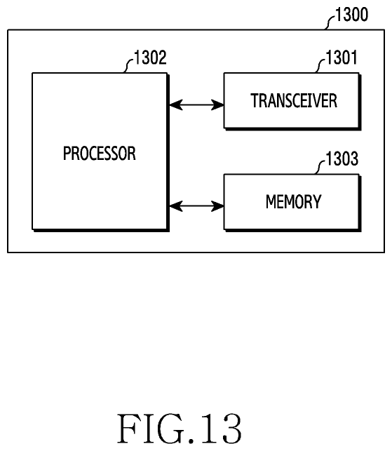

FIG. 13 is a block diagram illustrating a structure of a UE according to an embodiment of the disclosure.

Referring to FIG. 13, a UE 1300 may include a transceiver 1301, a controller (for example, at least one processor) 1302, and a storage unit (for example, memory) 1303. According to at least one or a combination of methods corresponding to the above-described embodiments of the disclosure, the transceiver 1301, the controller 1302, and the storage unit 1303 of the UE 1300 may operate. However, components of the UE 1300 are not limited to the illustrated example. According to another embodiment of the disclosure, the UE 1300 may include more components than the above-described components or include less components. Moreover, in a specific case, the transceiver 1301, the controller 1302, and the storage unit 1303 may be implemented as one chip.

According to an embodiment of the disclosure, the transceiver 1301 may include a transmitter and a receiver. The transceiver 1301 may transmit/receive signals with a gNB. The signals may include control information and data. The transceiver 1301 may include an RF transmitter configured to up-convert the frequency of transmitted signals and to amplify the same, and an RF receiver configured to low-noise-amplify received signals and to down-convert the frequency thereof. The transceiver 1301 may receive signals through a radio channel, output the same to the controller 1302, and transmit signals output from the controller 1302 through the radio channel.

The controller 1302 may control a series of procedures such that the UE 1300 can operate according to the above-described embodiments of the disclosure. For example, the controller 1302 may perform or control operations of the UE for performing at least one or a combination of methods according to embodiments of the disclosure. The controller 1302 may include at least one processor. For example, the controller 1302 may include a communication processor (CP) configured to perform control for communication, and an application processor (AP) configured to control upper layers (for example, applications).

The storage unit 1303 may store control information (for example, information related to channel estimation using DMRSs transmitted in a PUSCH included in a signal acquired by the UE 1300) or data, and may have an area for storing data necessary control by the controller 1302 and data generated during control performed by the controller 1302.

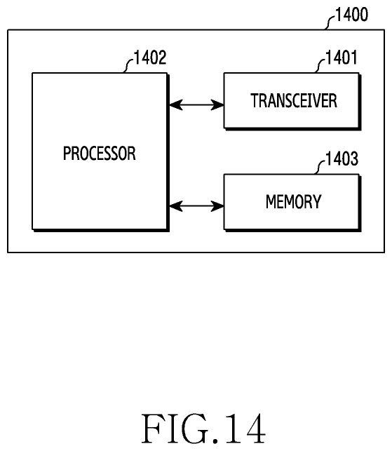

FIG. 14 is a block diagram illustrating a structure of a gNB according to an embodiment of the disclosure.

Referring to FIG. 14, a gNB 1400 may include a transceiver 1401, a controller (for example, processor) 1402, and a storage unit (for example, memory) 1403. According to at least one or a combination of methods corresponding to the above-described embodiments of the disclosure, the transceiver 1401, the controller 1402, and the storage unit 1403 of the gNB 1400 may operate. However, components of the gNB 1400 are not limited to the illustrated example. According to another embodiment of the disclosure, the gNB 1400 may include more components than the above-described components or include less components. Moreover, in a specific case, the transceiver 1401, the controller 1402, and the storage unit 1403 may be implemented as one chip.

According to an embodiment of the disclosure, the transceiver 1401 may include a transmitter and a receiver. The transceiver 1401 may transmit/receive signals with a UE. The signals may include control information and data. The transceiver 1401 may include an RF transmitter configured to up-convert the frequency of transmitted signals and to amplify the same, and an RF receiver configured to low-noise-amplify received signals and to down-convert the frequency thereof. The transceiver 1401 may receive signals through a radio channel, output the same to the controller 1402, and transmit signals output from the controller 1302 through the radio channel.

The controller 1402 may control a series of procedures such that the gNB 1400 can operate according to the above-described embodiments of the disclosure. For example, the controller 1402 may perform or control operations of the gNB for performing at least one or a combination of methods according to embodiments of the disclosure. The controller 1402 may include at least one processor. For example, the controller 1402 may include a communication processor (CP) configured to perform control for communication, and an application processor (AP) configured to control upper layers (for example, applications).

The storage unit 1403 may store control information (for example, information related to channel estimation generated by using DMRSs transmitted in a PUSCH determined by the gNB 1400), data, control information or data received from a UE, and may have an area for storing data necessary control by the controller 1402 and data generated during control performed by the controller 1402.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

According to an embodiment of the disclosure, a method performed by a UE in a wireless communication system may include monitoring a wake-up signal (WUS), receiving the WUS from a gNB, changing the state of a main radio receiver, based on the received WUS, and changing the state of a wake-up receiver (WUR), based on the changed state of the main radio receiver.

According to an embodiment of the disclosure, a method performed by a gNB in a wireless communication system may include transmitting a wake-up signal (WUS) to a UE having a wake-up receiver (WUR), and receiving feedback information regarding the WUS from the UE, wherein the WUS may include at least one of a WUS for identifying coverage and a WUS for changing the state of a main radio receiver of the UE.

A method performed by a user equipment (UE) in a wireless communication system is provided. The method comprises receiving, from a base station, configuration information associated with a wake-up signal (WUS) for a discontinuous reception (DRX) and monitoring the WUS within an occasion for the WUS based on the configuration information, while a group including the UE is in a DRX mode, wherein the WUS includes information on at least one sub-group associated with the WUS among the group.

The information on the at least one sub-group includes a bitmap corresponding to the at least one sub-group, or bits including a value corresponding to a sub-group among the at least one sub-group.

The value of the bits includes a first value for indicating that each of sub-groups included in the group does not need to wake up, or a second value for indicating each of the sub-groups needs to wake up.

The configuration information further includes information on a timer associated with the WUS, and wherein the method further comprises in case that the timer expires, identifying whether a system information block (SIB) received from the base station needs to be updated.

The configuration information includes first information on an offset for the WUS, and second information on a number of repetitions of the WUS, and wherein the WUS is repeatedly received from the base station within monitoring occasions included in the occasion for the WUS based on the first information and the second information.

The occasion for the WUS is earlier from an occasion for monitoring a physical downlink control channel (PDCCH) triggered by the WUS by an offset, and wherein information on the offset between the occasion for the WUS and the occasion for monitoring the PDCCH is included in the configuration information, or the information on the offset is configured with the UE based on an identity (ID) of the UE.

The method further comprises receiving, from the base station, a physical downlink control channel (PDCCH) triggered by the WUS within an occasion for monitoring the PDCCH, wherein the occasion for monitoring the PDCCH is later than a monitoring occasion in which the WUS is received by an offset, and wherein a stating symbol of the occasion for the WUS including the monitoring occasion is configured for the UE.

A user equipment (UE) in a wireless communication system is provided. The UE comprises a transceiver and a controller coupled with the transceiver and configured to receive, from a base station, configuration information associated with a wake-up signal (WUS) for a discontinuous reception (DRX), and monitor the WUS within an occasion for the WUS based on the configuration information, while a group including the UE is in a DRX mode, wherein the WUS includes information on at least one sub-group associated with the WUS among the group.

The information on the at least one sub-group includes a bitmap corresponding to the at least one sub-group, or bits including a value corresponding to a sub-group among the at least one sub-group.

The value of the bits includes a first value for indicating that each of sub-groups included in the group does not need to wake up, or a second value for indicating each of the sub-groups needs to wake up.

The configuration information further includes information on a timer associated with the WUS, and wherein the controller is further configured to identify whether a system information block (SIB) received from the base station needs to be updated, in case that the timer expires.

The configuration information includes first information on an offset for the WUS, and second information on a number of repetitions of the WUS, and wherein the WUS is repeatedly received from the base station within monitoring occasions included in the occasion for the WUS based on the first information and the second information.

The occasion for the WUS is earlier from an occasion for monitoring a physical downlink control channel (PDCCH) triggered by the WUS by an offset, and wherein information on the offset between the occasion for the WUS and the occasion for monitoring the PDCCH is included in the configuration information, or the information on the offset is configured with the UE based on an identity (ID) of the UE.

The controller is further configured to receive, from the base station, a physical downlink control channel (PDCCH) triggered by the WUS within an occasion for monitoring the PDCCH, wherein the occasion for monitoring the PDCCH is later than a monitoring occasion in which the WUS is received by an offset, and wherein a stating symbol of the occasion for the WUS including the monitoring occasion is configured for the UE.

A method performed by a base station in a wireless communication system is provided. The method comprises transmitting, to a user equipment (UE), configuration information associated with a wake-up signal (WUS) for a discontinuous reception (DRX) and transmitting, to the UE, the WUS within an occasion for the WUS based on the configuration information, while a group including the UE is in a DRX mode, wherein the WUS includes information on at least one sub-group associated with the WUS in the group.

The information on the at least one sub-group includes a bitmap corresponding to the at least one sub-group, or bits including a value corresponding to a sub-group among the at least one sub-group.

The value of the bits includes a first value for indicating that each of sub-groups included in the group does not need to wake up, or a second value for indicating each of the sub-groups needs to wake up.

A base station in a wireless communication system is provided. The base station comprises a transceiver and a controller coupled with the transceiver and configured to transmit, to a user equipment (UE), configuration information associated with a wake-up signal (WUS) for a discontinuous reception (DRX), and transmit, to the UE, the WUS within an occasion for the WUS based on the configuration information, while a group including the UE is in a DRX mode, wherein the WUS includes information on at least one sub-group associated with the WUS in the group.

The information on the at least one sub-group includes a bitmap corresponding to the at least one sub-group, or bits including a value corresponding to a sub-group among the at least one sub-group.

The value of the bits includes a first value for indicating that each of sub-groups included in the group does not need to wake up, or a second value for indicating each of the sub-groups needs to wake up.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a wireless communication system, the method comprising:
receiving, from a base station, configuration information associated with a wake-up signal (WUS) for a discontinuous reception (DRX); and
monitoring the WUS within an occasion for the WUS based on the configuration information, while a group including the UE is in a DRX mode,
wherein the WUS includes information on at least one sub-group associated with the WUS among the group.

2. The method of claim 1, wherein the information on the at least one sub-group includes a bitmap corresponding to the at least one sub-group, or bits including a value corresponding to a sub-group among the at least one sub-group.

3. The method of claim 2, wherein the value of the bits includes a first value for indicating that each of sub-groups included in the group does not need to wake up, or a second value for indicating each of the sub-groups needs to wake up.

4. The method of claim 1, wherein the configuration information further includes information on a timer associated with the WUS, and
wherein the method further comprises:
in case that the timer expires, identifying whether a system information block (SIB) received from the base station needs to be updated.

5. The method of claim 1, wherein the configuration information includes first information on an offset for the WUS, and second information on a number of repetitions of the WUS, and
wherein the WUS is repeatedly received from the base station within monitoring occasions included in the occasion for the WUS based on the first information and the second information.

6. The method of claim 1, wherein the occasion for the WUS is earlier from an occasion for monitoring a physical downlink control channel (PDCCH) triggered by the WUS by an offset, and
wherein information on the offset between the occasion for the WUS and the occasion for monitoring the PDCCH is included in the configuration information, or the information on the offset is configured with the UE based on an identity (ID) of the UE.

7. The method of claim 1, further comprising:
receiving, from the base station, a physical downlink control channel (PDCCH) triggered by the WUS within an occasion for monitoring the PDCCH,
wherein the occasion for monitoring the PDCCH is later than a monitoring occasion in which the WUS is received by an offset, and
wherein a stating symbol of the occasion for the WUS including the monitoring occasion is configured for the UE.

8. A user equipment (UE) in a wireless communication system, the UE comprising:
a transceiver; and
a controller coupled with the transceiver and configured to:
receive, from a base station, configuration information associated with a wake-up signal (WUS) for a discontinuous reception (DRX), and
monitor the WUS within an occasion for the WUS based on the configuration information, while a group including the UE is in a DRX mode,
wherein the WUS includes information on at least one sub-group associated with the WUS among the group.

9. The UE of claim 8, wherein the information on the at least one sub-group includes a bitmap corresponding to the at least one sub-group, or bits including a value corresponding to a sub-group among the at least one sub-group.

10. The UE of claim 9, wherein the value of the bits includes a first value for indicating that each of sub-groups included in the group does not need to wake up, or a second value for indicating each of the sub-groups needs to wake up.

11. The UE of claim 8, wherein the configuration information further includes information on a timer associated with the WUS, and
wherein the controller is further configured to:
in case that the timer expires, identify whether a system information block (SIB) received from the base station needs to be updated.

12. The UE of claim 8, wherein the configuration information includes first information on an offset for the WUS, and second information on a number of repetitions of the WUS, and
wherein the WUS is repeatedly received from the base station within monitoring occasions included in the occasion for the WUS based on the first information and the second information.

13. The UE of claim 8, wherein the occasion for the WUS is earlier from an occasion for monitoring a physical downlink control channel (PDCCH) triggered by the WUS by an offset, and
wherein information on the offset between the occasion for the WUS and the occasion for monitoring the PDCCH is included in the configuration information, or the information on the offset is configured with the UE based on an identity (ID) of the UE.

14. The UE of claim 8, wherein the controller is further configured to:
receive, from the base station, a physical downlink control channel (PDCCH) triggered by the WUS within an occasion for monitoring the PDCCH,
wherein the occasion for monitoring the PDCCH is later than a monitoring occasion in which the WUS is received by an offset, and
wherein a stating symbol of the occasion for the WUS including the monitoring occasion is configured for the UE.

15. A method performed by a base station in a wireless communication system, the method comprising:
transmitting, to a user equipment (UE), configuration information associated with a wake-up signal (WUS) for a discontinuous reception (DRX); and
transmitting, to the UE, the WUS within an occasion for the WUS based on the configuration information, while a group including the UE is in a DRX mode,
wherein the WUS includes information on at least one sub-group associated with the WUS among the group.

16. The method of claim 15, wherein the information on the at least one sub-group includes a bitmap corresponding to the at least one sub-group, or bits including a value corresponding to a sub-group among the at least one sub-group.

17. The method of claim 16, wherein the value of the bits includes a first value for indicating that each of sub-groups included in the group does not need to wake up, or a second value for indicating each of the sub-groups needs to wake up.

18. A base station in a wireless communication system, the base station comprising:
a transceiver; and
a controller coupled with the transceiver and configured to:
transmit, to a user equipment (UE), configuration information associated with a wake-up signal (WUS) for a discontinuous reception (DRX), and
transmit, to the UE, the WUS within an occasion for the WUS based on the configuration information, while a group including the UE is in a DRX mode,
wherein the WUS includes information on at least one sub-group associated with the WUS among the group.

19. The base station of claim 18, wherein the information on the at least one sub-group includes a bitmap corresponding to the at least one sub-group, or bits including a value corresponding to a sub-group among the at least one sub-group.

20. The base station of claim 19, wherein the value of the bits includes a first value for indicating that each of sub-groups included in the group does not need to wake up, or a second value for indicating each of the sub-groups needs to wake up.
